(19) United States
(12) Patent Application Publication
(10) Pub. No.: US 2010/0223314 A1
(43) Pub. Date: Sep. 2, 2010

(54) APPARATUS AND METHOD FOR CREATING AND TRANSMITTING UNIQUE DYNAMICALLY PERSONALIZED MULTIMEDIA MESSAGES

(75) Inventors: Isser Gadel, Herzliah B (IL); Nimrod Sabag, Kiryat Motzkin (IL)

Correspondence Address: DEBORAH A. GADOR, P.O. BOX 4133, GANEL TIKVA, 55900, IL

(73) Assignee: CLIP IN TOUCH INTERNATIONAL LTD, Natanya (IL)

(21) Appl. No.: 12/161,168

(22) PCT Filed: Jan. 4, 2007
(86) PCT No.: PCT/IL2007/000010

§ 371 Date: Jul. 17, 2008

(30) Foreign Application Priority Data
Jan. 18, 2006 (IL) 173222

(51) Int. Cl. G06F 13/00

(52) U.S. Cl. 709/200

(57) ABSTRACT

An apparatus and method for the creation and transmission of dynamically personalized multimedia messages includes a client device running a multimedia message assembler. The client device is linked via a communication network to a server device running server-side software and linked to remote receiver devices. The multimedia messages are sent to the remote receivers via the network and the server device. The server device includes a media-type content type database and a multimedia access and play software.

### BACKGROUND OF THE INVENTION

1. Field of the Invention

The present invention relates to an apparatus and method for creating and sending unique dynamically personalized multimedia messages to a remote receiver in general and more particularly, to an apparatus and method for generating, capturing, selecting, recording, and assembling input media segments into a unique dynamically personalized multimedia message file and transmitting the personalized multimedia message file for access and display to a remote receiver operating a multimedia access and display device.

2. Discussion of the Related Art

Multimedia is a general term used to describe any application or technology that can be used to manipulate text, audio, images, graphics, and video. Multimedia provides a level interactivity with each of these elements separately, as well as through combinations of different multimedia mediums. In business, there is a plurality of ways in which the application of multimedia technology may be desired, whether for means of efficiency or increased productivity. Multimedia is typically includes one of the following: a) text and sound b) text, sound, and still or animated graphic images c) text, sound, and video images, d) video and sound, and e) multiple display areas, images, or presentations presented concurrently. Multimedia has found major users in the fields of advertising, web design, electronic publishing, technical documentation, information and asset management, and education.

Multimedia software is used typically in computers to present text, graphics, video, animation, and sound in an integrated way. Multimedia software is typically built of two basic components: a multimedia generator or multimedia assembler with which multimedia applications are created, and a multimedia access which enables access to the information gathered in the applications.

Recently electronic mail-based and cellular telephone-based multimedia messaging became basic communication tools the use of which has become widespread. Multimedia communication provides the advantage of an enriched medium in which expression, feeling, emotion and mood as well as content can be conveyed. Today, electronic mail systems and cellular telephone systems in which the user is able to create, store, send, forward and attach multimedia messages to regular e-mail messages are well known and are part of the communication tools used by many on a daily basis.

Multimedia messaging is a communications technology that allows users to exchange multimedia communications between capable mobile phones and other devices, such as personal computers. Multimedia messaging defines a way to send and receive, almost instantaneously, wireless messages that include images, audio, and video clips in addition to text. A common current application of multimedia messaging is picture messaging or the use of camera phones to take photos for immediate delivery to a mobile recipient. Other possibilities include animations and graphic presentations of stock quotes, sports news, and weather reports. One problem associated with such mail and cellular systems is that they do not provide for advanced media types, such as for example streaming video. Another problem is that the existing systems provide only for multimedia messaging based on pre-prepared and pre-stored non-flexible media forms. The options for choosing one of the media forms and the personalization of the standard forms are fairly limited. Typically, a user desiring to send a multimedia message is given the option to select a pre-prepared and pre-stored multimedia message out of a set of pre-prepared messages that are stored in the system and are arranged by categories and sub-categories or groups to provide for a limited variety in respect of the expression and the moods sought by the user. For example, if the user desires to send a greeting card, he could select one of several categories, such as greeting cards, one of several sub-categories, such as birthday cards, wedding anniversary cards, seasonal greeting cards or the like. Once a certain pre-prepared message is selected by the user, the message can be personalized only in a substantially limited manner, such as for example, by generating an accompanying text by keying in a text segment to be inserted in a pre-determined format into a pre-determined space in the body of the message. The existing systems do not allow for enhanced and advanced personalization of the messages, such as enabling the selection of the visual elements, such as introducing one or more still images, enabling the addition of desired audio elements, such as specific songs including vocals and/or instrumental music, enabling the selection and insertion of specific text in a variety of formats, and locations, enabling the addition of personally recorded or personally captured media types and the like.

It would be readily perceived by one with ordinary skills in the art that there is a need for an advanced apparatus and a user-friendly method that will provide for enhanced and advanced personalization of multimedia messages, such as enabling the selection of the visual elements, enabling the addition of desired audio elements, enabling the selection and insertion of specific text elements in a variety of formats, and locations, and enabling the addition of personally recorded or personally captured media types.

### SUMMARY OF THE PRESENT INVENTION

One aspect of the present invention regards an apparatus for the creation and transmission of personalized multimedia messages. The apparatus comprises: a multimedia message assembler for creating a multimedia message by assembling and manipulating diverse media type content segments, a shared creative content database to store diverse media type content segments and to provide the diverse media type content segments to the multimedia message assembler in response to a request; and a multimedia message forwarding mediator to receive multimedia messages and receivers addresses associated therewith, to communicate with a receiver device, to reformat the multimedia message according to the multimedia capabilities of the receiver device, and to forward the multimedia message to the receiver device.

A second aspect of the present invention regards a method for the creation and transmission of unique personalized multimedia messages from a sending device to a receiver device. The method comprises obtaining media type content segments from a shared creative content database, creating a multimedia message by assembling and manipulating the diverse media type content segments, and forwarding the multimedia message to the receiver device.

### BRIEF DESCRIPTION OF THE DRAWINGS

The present invention will be understood and appreciated more fully from the following detailed description taken in conjunction with the drawings in which:

FIG. 1 is a schematic illustration of a computing and communication environment in which the proposed apparatus could operate, in accordance with a first preferred embodiment of the present invention;

FIG. 2 is a simplified block diagram of the sending device, in accordance with the first preferred embodiment of the present invention;

FIG. 3 is a simplified block diagram of the server device, in accordance with the first preferred embodiment of the present invention;

FIG. 4 is a simplified block diagram of the operative modules of the sending and the server devices, in accordance with the first preferred embodiment of the present invention;

FIG. 5 is a schematic representation of the user interface display providing for the selection and manipulation of the video segment, in accordance with the first preferred embodiment of the present invention;

FIG. 6 is a schematic representation of the user interface display providing for the selection and manipulation of the audio segment, in accordance with the first preferred embodiment of the present invention;

FIG. 7 is a schematic representation of the user interface display providing for the selection and manipulation of the text segment, in accordance with the first preferred embodiment of the present invention;

FIG. 8 is a schematic representation of the user interface display associated with a karaoke sub-system, in accordance with the first preferred embodiment of the present invention;

FIG. 9 is a simplified view of the novel and unique karaoke text and control file, in accordance with the first preferred embodiment of the present invention;

FIG. 10 is a simplified flow chart of main logic of the proposed method, in accordance with the first preferred embodiment of the present invention;

FIG. 11 is a simplified flow chart of the audio media handling associated with the proposed method, in accordance with the first preferred embodiment of the present invention;

FIG. 12 is a simplified flow chart of the video media handling associated with the proposed method, in accordance with the first preferred embodiment of the present invention;

FIG. 13 is a schematic illustration of a computing and communication environment in which the proposed apparatus could operate, in accordance with a second preferred embodiment of the present invention; and

FIGS. 14, 15 and 16 are simplified flow charts presenting the operation of the proposed method, in accordance with the second preferred embodiment of the present invention.

### DETAILED DESCRIPTION OF THE PREFERRED EMBODIMENT

An apparatus and method for the creation and transmission of unique dynamically personalized multimedia messages is disclosed. The apparatus includes a sending device, such as a cellular telephone with enhanced computing and multimedia display capabilities or a personal computer, running client-side software. The sending device is linked communicatively via a data communication network, such as the Internet, or via a cellular communications network, to a computing machine utilized as a server device running server-side software. The server device is linked communicatively to remote receiver devices such as client devices across the data communications network and/or cellular telephones via a gateway device between the data communications network and a cellular telephone network. The sending device could include private libraries of media-types content, media-types content capturing (recording), media-type content input and media-type content temporary storage devices while the server device includes a media-type content type database, multimedia access and multimedia play software. The apparatus may further include specific development tools for generating, synchronizing, coding, and encrypting a novel karaoke text and control file format.

In the preferred embodiments of the present invention the content of the multi-media message is a unique dynamically personalized greeting message. The greeting message is a social expression that includes the sending of salutations, regards, respects, remembrance, felicitations, well-wishing, compliments, or best wishes created from one individual and delivered to one or more other individuals. In other preferred embodiments of the invention the content and the purpose of the multi-media message could be different, such as unique targeted advertising content for commercial purposes, unique personalized musical/audio clips or gaming content for professional or amateur entertainment purposes, and the like.

In the preferred embodiments of the present invention the multi-media message is created from multiple media-type content inputs having diverse formats within digitally stored libraries and provide for the creation and transmission of unique dynamically personalized multimedia messages. The media-type content inputs include stored video, stored audio, stored still images, stored still image sequences, stored text, and stored karaoke. The media-type inputs could be digitally stored in specific libraries on the sending device or on the server device or could be captured from various, magnetic media or optic media, such as magnetic disks or DVDs. The media-type content inputs could be further captured from recording devices connected to the sending device, such as a camcorder, a microphone, a keyboard, and the like. In other preferred embodiments the media-type contents could further include animation segments, icons, graphics either digitally stored in specific media-type content libraries or captured from various media sources, such as downloading from a data communications network, and the like.

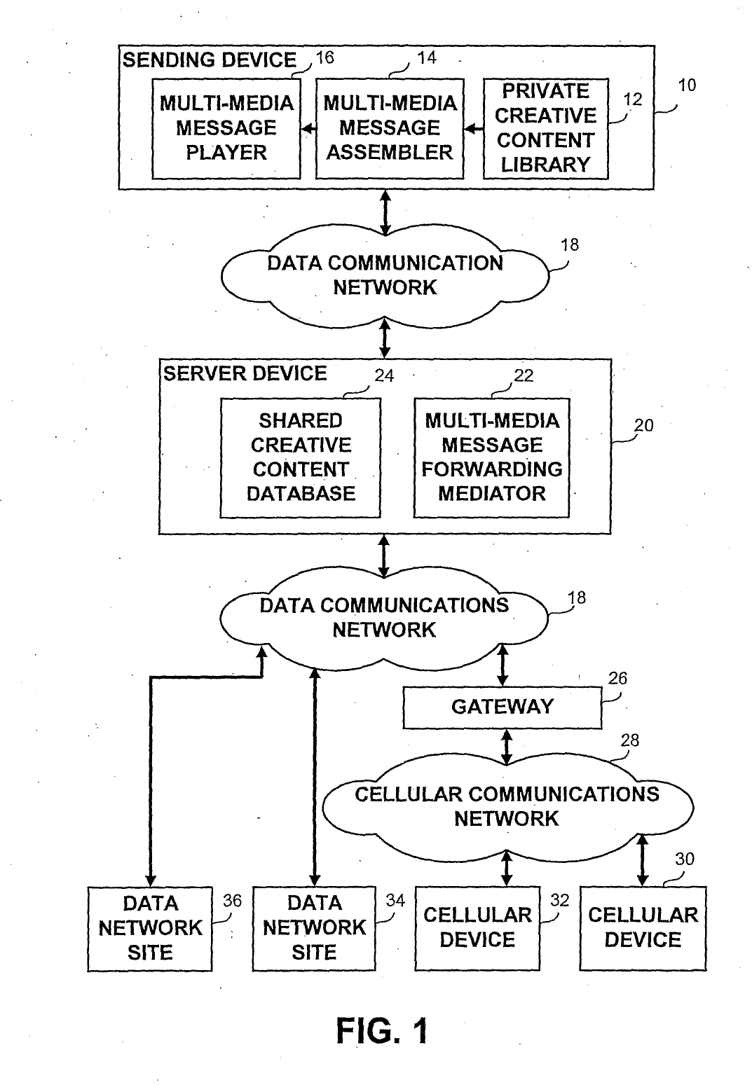

Referring now to FIG. 1 which is a schematic illustration of a computing and communication environment in which the proposed apparatus could operate, in accordance with a first preferred embodiment of the present invention. Sending device 10 is a computing device with communications capabilities, such as a personal desktop computer, a network computer, a mainframe computer, or any other computing device operated by a user. Device 10 is communicatively linked to a data communication network 18, such as the Internet. Device 10 includes a multimedia message assembler 14 to create a unique dynamically personalized multimedia message, a multimedia message player 16 to preview the multimedia message, and a private creative content library 12 to store temporarily downloaded, captured and recorded media-type content segments and to hold multimedia message output and control files. Multimedia message assembler 14 is a set of inter-related software programs the functionality of which is to manipulate the media-type content segments in order create, to compose, to assemble, to produce and to transmit the unique dynamically personalized multimedia output message. Multimedia message player 16 is a set of logically inter-related software programs the functionality of which is to allow for the playing of the unique multimedia output message in all the stages of the production in order to provide for previewing of the multimedia message. Private creative content library 12 is a database installed on a memory device (not shown) of sending device 10. Library 12 stores media-type content input for multimedia message assembler 14 to operate upon and other temporary files needed for the running of multimedia message assembler 14. The multimedia message is provided with a suitable target address, transmission scheduling parameters, and transmitted via diverse communication software, hardware and lines to server device 20 via data communications network 18. Server device 20 is a computing device the functionality of which is: a) to provide requested media-type content segments as input to sending device 10 via data communication network 18, b) to receive the unique multimedia message from sending device 10 and to transmit the message to one or more target devices 30, 32, 34, 36 via data communications network 18 or via an inter-network gateway device 26 and consequently to a cellular communications network 28. The receiver devices 30, 32 are linked to cellular communications network 28. The receiver devices 30, 32 are cellular communications devices, such as cellular telephones. The receiver devices 34 and 36 are linked communicatively to data communications network 18. Devices 34 and 36 are computing devices with communication capabilities and with multimedia content playing capabilities. Multimedia message is received by receiver devices 30, 32, 34 and 36 are replayed by the user of devices 30, 32, 34 and 36 in order to perceive the content of the message. Server device 20 includes a shared creative content database 24 and a multimedia message forwarding mediator 22. Database 24 is a data structure for storing media type content segments. In response to requests of the user of sending device 10 specific media-type content segments are transmitted to sending device 10 in order to supply the user of device 10 with the media elements for the creation of the multimedia message. Multimedia message forwarding mediator 22 is a software program for the handling of the received multimedia messages, such as receiving the messages, communicating with the receiver devices, responding to the capabilities of the receiver devices, optionally re-formatting the messages in accordance with the characteristics of the receiver devices and forwarding the message to the receiver devices. Server 20 is further responsible for generating and transmitting error messages or other feedback messages to sending device 10 concerning the results of the message delivery process.

Still referring to FIG. 1 note should be taken that although on the drawing under discussion only a single sending device, a single server device and a few target devices are shown, in a realistic environment a plurality of sending devices could create a plurality of multimedia output messages and transmit the messages to a plurality of target devices via a plurality of server devices. Further note should be taken that in other preferred embodiments of the present invention, diverse other communications network could be used, such as a local area network, a satellite communication network, a landline telephone network, a cable communications network or the combinations thereof. In yet other preferred embodiments of the invention, the server device 20 could be dispensed with and the entire message transmission process could be performed by sending device 10 and receiver devices 30, 32, 34 and 36. In such a case the shared creative content database 24 could be installed in the sending device 10 while the multimedia message handling, such as message reception, message re-formatting, error processing, and feedback generation and transmission could be performed by the receiver devices 30, 32, 34 and 36. It would be easily perceived by one with ordinary skills in the art that subject to the installed software, sending device 10 is capable of functioning as a receiver device or a sending/receiver while receiver devices 30, 32, 34, 36 subject to the installed software could be functioning as sending devices or receiver/sending devices.

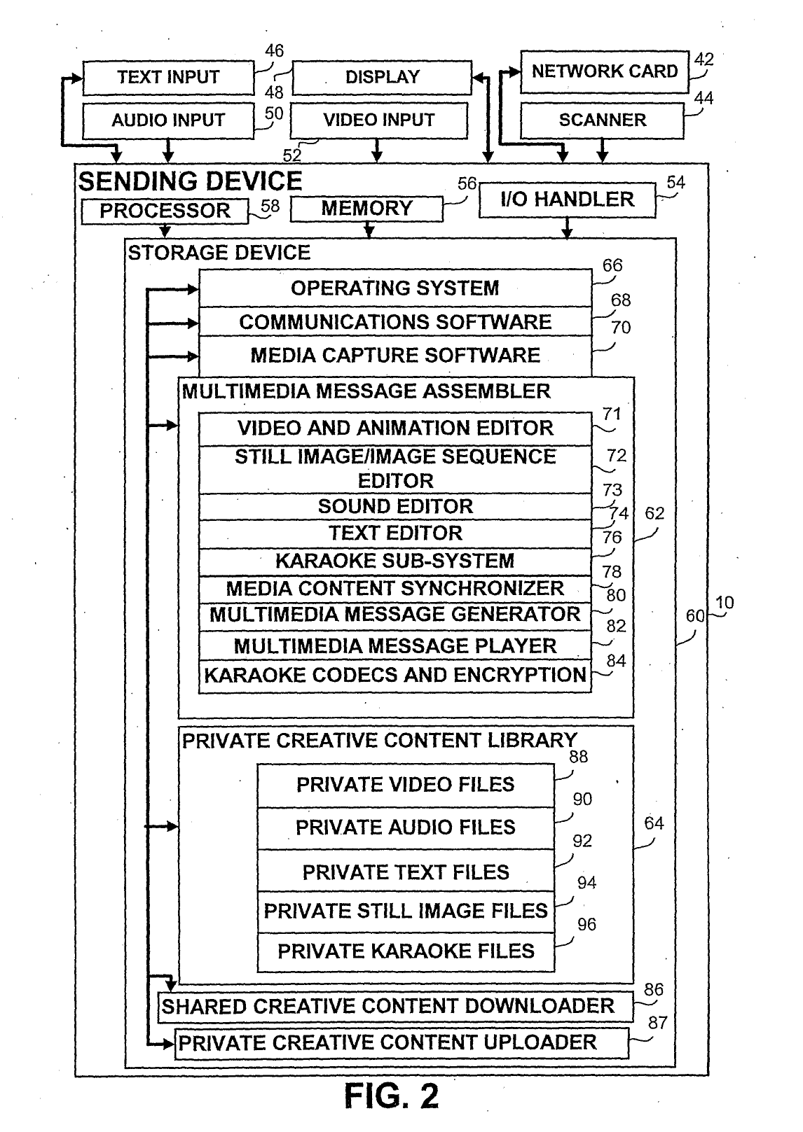

Referring now to FIG. 2 in the first preferred embodiment of the invention, sending device 10 is a computing device, such as a personal computer, network computer, mainframe computer or the like with communications capabilities. Sending device 10 includes a processor device 58, a memory device 56, such as a RAM, a ROM, a PROM, or an EPROM, an I/O handler device 54 and a storage device 60, such as a magnetic disk or an optical disk. Several peripheral devices are attached to sending device 10. The peripheral devices include a text input device 46, such as a keyboard, a mouse, a display device 48, such as an LCD screen or a plasma screen, a network interface card 42, an audio input device 50, such as a microphone, a video input device 52, such as a camcorder or a Web camera, and a scanner device 44. Processor 58 is the logic circuitry that responds to and processes the basic instructions that drive a computer. Processor 58 when installed in a personal computer or embedded in small devices is typically a microprocessor. Memory 56 is the electronic holding place for instructions and data that the computer's processor can reach quickly. Memory 58 is distinguished from storage device 60 that holds the much larger amounts of data that would not fit into RAM and may not be immediately needed there. Storage devices include hard disks, magnetic disks, optical disks, floppy disks, CD-ROM, and tape backup systems. I/O handler 54 is the program a computer's processor uses to get the computer system started after it is turned on and manages data flow between the computer's operating system and attached devices such as the hard disk, video adapter, keyboard, mouse, and printer. The primary text input device 46 is a keyboard. Scanner 44 is a device that captures images from photographic prints, posters, magazine pages, and similar sources for computer editing, display and storage. Scanner 44 typically comes with software, such as Adobe's Photoshop product. Primary audio input device 50 is a microphone which is a transducer that converts sound into electrical signal. Primary video input device 52 is a camcorder which is an electronic device (typically a digital camera) containing both a camera and a recorder in one emit for recording video images and audio onto storage device 60. Network interface card 42 (also called network adapter, MC and the like) is a piece of computer hardware designed to allow computers to communicate over a data communications network.

Still referring to FIG. 2 storage device 60 includes an operating system 66, a communications software 68, a media capture software 70, a multimedia message assembler 62, a private creative content library 64, a shared creative content downloader module 86, and a private creative content uploader module 87. Operating system 66 is the system software responsible for the direct control and management of hardware and basic system operations and it provides a foundation upon which to run application software such as word processing programs, web browsers and others. Media capture software 70 is logically coupled to peripheral devices and is responsible for capturing media-type content input from all the suitable sources, such as the Internet, private library, recording input devices, portable storage devices and the like. Communications software 68 is responsible for the performance of communications in association with the network interface card 42. Multimedia message assembler 62 is the primary client-side software. The functionality of assembler 62 is to provide the user with the option of selecting, creating, assembling, playing and transmitting a multimedia message file. Assembler 62 is capable of respond to the user's requests regarding: a) obtaining media-type content segments, b) editing, mixing, layering, combining, manipulating, joining, replacing, separating media-type content segments, such as to create a multimedia output message file, c) obtaining transmission parameters, such as date of transmission, target address, and the like, d) storing a multimedia output control file, e) capturing and recording media-type segments, and f) sending captured media-type content segments for storage in a shared remote database or a local library for later use. Multimedia message assembler 62 is a set of logically inter-related software programs. Assembler 62 includes a video and animation editor module 71 for manipulating video and animation segments; a still image/image sequence editor module 72 for manipulating still image segments; a sound editor module 73 for manipulating audio segments; a text editor module 74 for manipulating text segments; a karaoke sub-system 76 for recording customized vocals on pre-defined instrumental music segments; a media-type synchronizer module 78 to synchronize audio input, video input, text input, animation input and recorded input; a multimedia output message generator module 80 to create a multimedia output message from the synchronized media-type segments; a multimedia message player module 82 for previewing the multimedia output message; and a karaoke coder-decoder and encryption/decryption module 84 for generating novel unique karaoke text/controls file. Private creative content library 64 stores private media-type segments that include private video files 88, private audio files 90, private text files 92, private still image files 94, and private karaoke files 96. Shared creative content downloader module 86 receives requests from the user concerning a required media type content input, locates the requested media-type content input on the server device 20 of FIG. 1 and downloads media-type content input from the server device 20 to the sending device 10. Private creative content uploader module 87 receives requests from the user concerning the transmission of the media-type content input from the private creative content library 64 on the sending device 10 and uploads the media-type content input from the sending device 10 to the shared creative content database 24 on the server device 10 of FIG. 1.

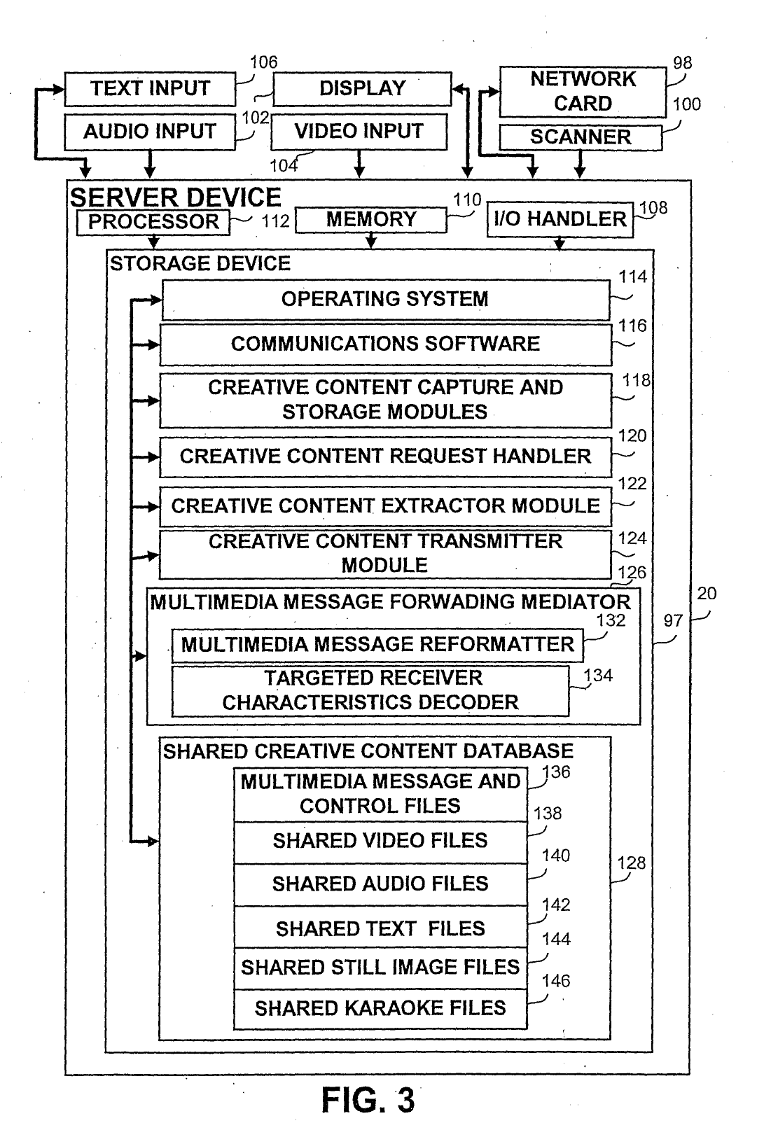

Referring now to FIG. 3 server device 20 is a computing device, such as a personal computer, network computer, mainframe computer or the like with communications capabilities. Server device 20 includes a processor device 112, a memory device 110, such as a RAM, a ROM, a PROM, or an EPROM, an I/O handler device 108 and a storage device 97, such as a magnetic disk or an optical disk. Several peripheral devices are attached to server device 20. The peripheral devices include a text input device 106, such as a keyboard or a mouse, a display device 102, such as an LCD screen or a plasma screen, a network interface card 98, an audio input device 102, such as a microphone, a video input device 104, such as a camcorder or a Web camera, and a scanner device 100. Storage device 97 includes an operating system 114, communications software 116, creative content capture and storage module 118, a creative content request handler 120, a creative content extractor module 122, a creative content transmitter 124, a multimedia message forwarding mediator 126 and a shared creative content database 128. Multimedia message forwarding mediator 126 includes a multimedia message reformatter 132, and a receiver device characteristics decoder 134. Shared creative content database 128 includes multimedia control files 136, shared video files 138, shared audio files 140, shared text files 142, shared still image files 144 and shared karaoke files 146. The functionality of creative content capture and storage modules 118 is to capture media-type content segments via the appropriate peripheral devices, such as network interface card 98, scanner 100, video input 104, audio input 102, and the like. The captured media-type content segments are suitably categorized, grouped, indexed, structured, encoded, encrypted and digitally stored in the shared creative content database 128. Note should be taken that the source of the media-type content segments could be the private creative content library 64 of sending device 10 of FIG. 2. Further sources could be any other site across the data communications network, such as regular content provider sites. Yet further sources could be portable storage devices, such as magnetic or optical disks, scanned text documents, scanned graphics, and the like. Creative content request handler 120 is responsible for responding to request of the user of sending device 10 of FIG. 2 via shared creative content downloader module 86. Handler 120 will respond to the request by passing the identification of the shared file to the creative content extractor module 122 that will obtain the requested file from database 128 and will transmit the file via creative content transmitter 124 to sending device 10 of FIG. 2. Creative content transmitter module 124 is responsible for: a) transmitting the requested shared creative content files to the sending device 10 of FIG. 1 and b) forwarding the multimedia message received from sending device 10 to receiver devices 30, 32, 34 and 36 of FIG. 1. Multimedia message forwarding mediator 126 receives the multimedia message from sending device 10 via data communications network 18 and extracts the transmission scheduling parameters and the targeted address from the message. Mediator 126 will generate a Short Message Service (SMS) message to the receivers 30, 32, 34 and 36 in order to obtain the multimedia-related capabilities of the receivers 30, 32, 34 and 36 via the receiver characteristics decoder module 134. In accordance with the obtained results the multimedia message could be handled in one of three alternative ways: a) if the multimedia playing capabilities of the receiver entirely match the formats of the multimedia message then the message is forwarded to the receiver in the original format according to the transmission scheduling parameters, b) if the multimedia playing capabilities of the receiver partially match the formats of the multimedia message then the message is reformatted to match the playing capabilities of the receiver and transmitted according to the transmission scheduling parameters, and c) if the multimedia playing capabilities of the receiver do not match the formats of the multimedia message then the message the multimedia message output and an associated multimedia control file are stored on the server device 20 while simultaneously a feedback message indicating multimedia player incompatibility is sent to the sending device 10 of FIG. 2 and a text message is forwarded to the receiver indicating the lack of capability for the playing the multimedia message on the receiver device 30, 32, 34 and 36, the address of the sending device, such as sending device 10, and the options for the receiver regarding the appropriate display of the multimedia message, such as accessing the server device 20 directly and submitting a request for the playing of the multimedia message stored on the server device 20. The function of shared creative content database 128 is storing the shared media-type content segments, such as shared video files 138, shared audio files 140, shared text files 142, shared still image files 144, and shared karaoke files 146. The files 138, 140, 142, 144 and 146 could be accessed and obtained by the user of sending device 10 for downloading to sending device 10 in order to be manipulated such as to create a multimedia message output file. The user of sending device 10 could also upload private media-type content files 88, 90, 92 and 96 from sending device 10 in order to insert the private files into shared creative content database 128 and mark them as either shared files or private files. Optionally, shared creative content database 128 further stores unique personalized multimedia message and control files 136 received from sending device 10.

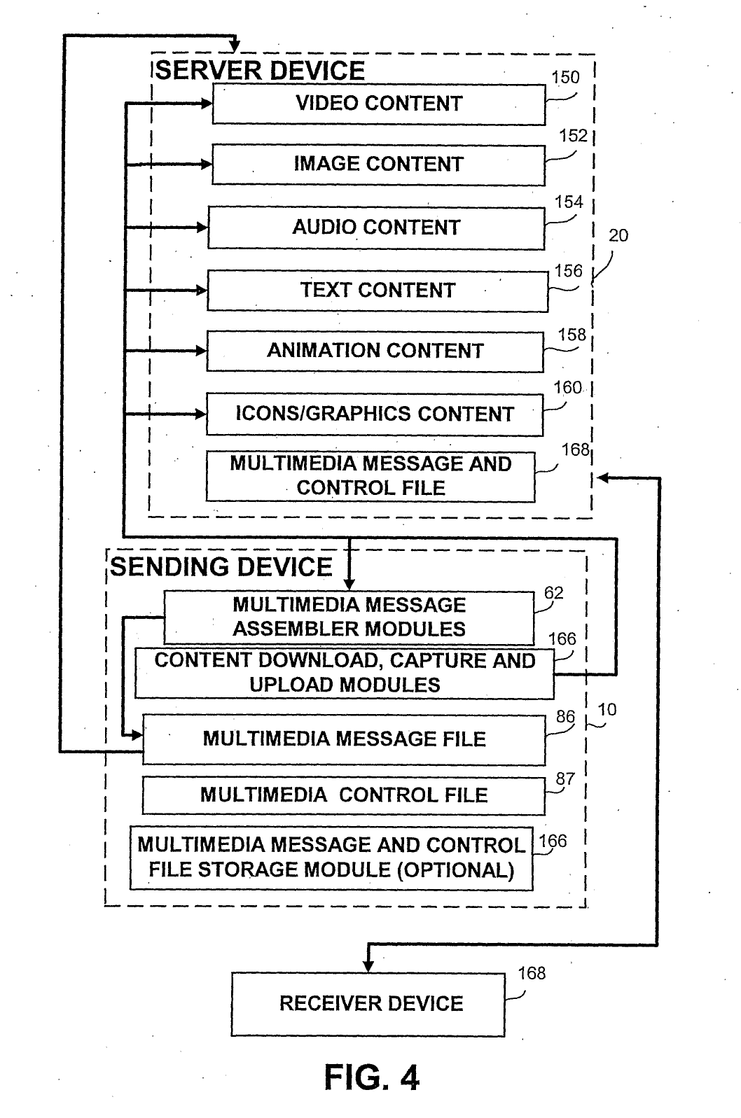

Referring now to FIG. 4 when a user operating sending device 10 desires to create and send a multimedia message, such as a multimedia greeting message, the multimedia message assembler modules 62 are activated. Assembler 62 enables the user to select a greeting message type, such as a text message, a voice recording, a still image sequence with text or overlaid thereon. In accordance with the selected greeting message type the assembler 62 allows the user of sending device 10 to select one of the media-type categories and media-type groups that the user desires to be a part of the multimedia greeting message. In accordance with selected media-type, media-type category and media-type group the assembler 62 downloads via the Internet from server device 20 one or more media-type content segments stored in the suitably ordered data records, such as video content 150, image content 152, audio content 154, text content 156, animation content 158, and icons/graphics content 160. The sending device could further capture media-type content segments and upload the captured segments to the server device 20 via the content download, capture and upload modules 166. The downloaded media-type, media-category, and media-group content segments are displayed to the user for selection, editing, joining, mixing, deleting, replacing, previewing or otherwise manipulating. When the user completes the manipulation of a selected content segment assembler 62 enables the selection of a media-type that matches the logical combination of the media-types constituting the multimedia greeting message. Thus, a greeting in the image-sequence format could include the selection and manipulation of one or more still images, audio segments and text segments, while a greeting in audio format could include one or more audio segments overlaid by text segments. When the user completes the creation of a multimedia greeting message a multimedia message output file 86 and a multimedia message control file 87 are generated and optionally saved by the multimedia message and control file storage module 166. When the user wishes to transmit the multimedia greeting message file then a set of required parameters is submitted, such as one or more receiver address, transmission scheduling data and the like. The message is transmitted to the receiver device 168 via a data communications network or via a cellular communications network via the server device 20 for replay by the user of the receiver device 168.

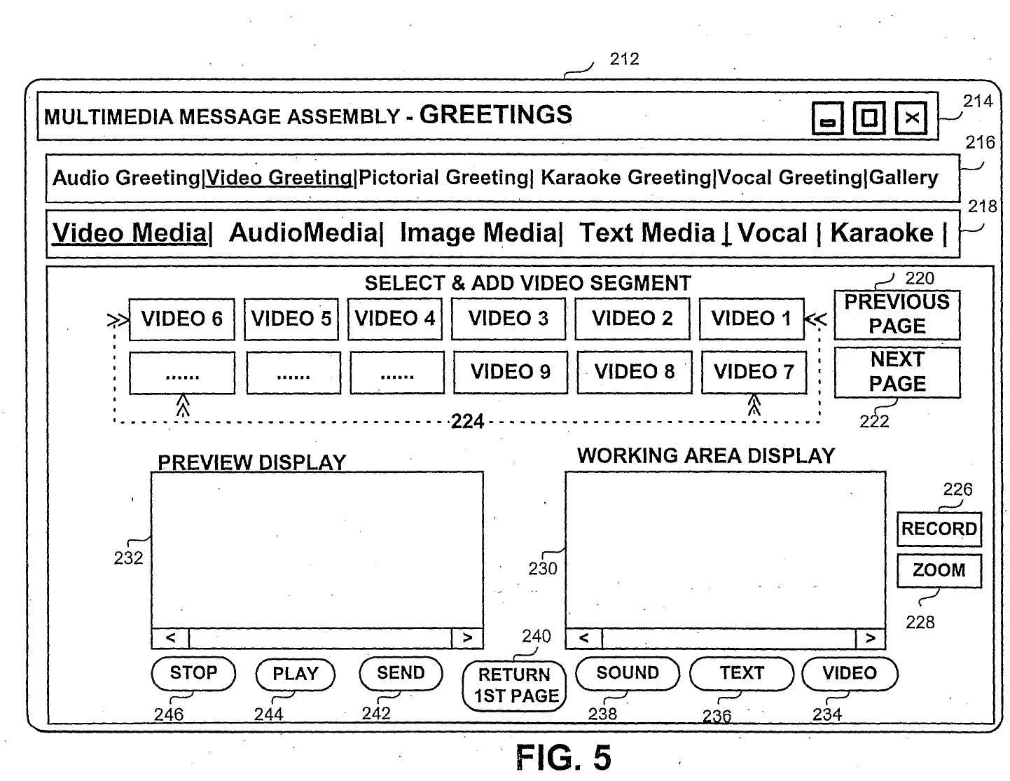

Referring to FIG. 5 in the first preferred embodiment of the present invention, the user interface designed for the apparatus and method is a Graphical User Interface (GUI). A graphical user interface is a method of interacting with a computer through a metaphor of direct manipulation of graphical structures in addition to text. GUIs display visual elements such as icons, windows, and the like. GUIs consists of graphical structures such as windows, menus, radio buttons, check boxes, list boxes and icons and employs a pointing device (such as a mouse, trackball, or touch screen) in addition to a keyboard. The window 212 is one out of a plurality of windows designed to interact with and guide a user of the sending device 10 of FIG. 1 in the creation and transmission of a multimedia message containing a multimedia greeting. The window 212 is one of a logically interconnected set of windows that appear either by user selection or in a substantially pre-defined manner following the selection for a multimedia message type and for a media type. The function of window 212 (and all the other windows participating in the creation and transmission of the multimedia message) is to interact dynamically with the user and enable the user a) to display one or more video segments that could be part of the multimedia greeting, b) to select one or more video segments that could be part of the multimedia message, b) to manipulate the video segments, c) to preview the multimedia message containing a multimedia greeting, d) to record a video segment via a recording device, and e) to create and send a composite multimedia greeting that includes either the manipulated video segments only or includes previously created multimedia greeting that were manipulated in other windows. Window 212 includes a window header 214, a greeting message type window 216, a media-type window 218, a preview display 232, a working area display 230, a set of media-type segments displays page 224, displays pages manipulator buttons 220, 222 and 240, a set of preview manipulation buttons 246, 244 and 242, a set of working area manipulation buttons 238, 236 and 234, and other special purpose buttons 226 and 238. Window header 214 includes the description of the program name, and various window-manipulation buttons (hide, maximize, minimize) Greeting message type window 216 includes several menu items associated with greeting message types, such as audio format greeting, video format greeting, image-sequence format greeting, text format greeting, vocal format greeting, and karaoke format greeting. Pointing at one of the menu items and clicking the pointing device will affect the selection of a greeting message type. According to the selected greeting message type in window 216 one or more menu items are displayed in window 218 corresponding to specific media-types potentially assembled into the multimedia message containing the multimedia greeting are either enabled or disabled for selection. Thus, for example when the menu item “Video Greeting” corresponding to the creation of a video greeting message type is selected then in window 218 the menu items “Video Media”, “Audio Media”, “Text Media” are enabled. The selection of one of the menu items “Video Media”, “Audio Media”, and “Text Media” will display windows designed for the manipulation of the corresponding video, audio or text media-types that could be assembled into the multimedia message. Window 212 is designed for the manipulation of video media-type. Thus, when greeting type “Video Greeting” and the media-type “Video Media” is selected then a window (not shown) for the selection of video media content categories and optionally of video media content groups stored in the shared creative content database 64 of FIG. 1 on the server device 20 of FIG. 1 will be displayed to allow the user to select the suitable video content category and video content group. Consequent to the selection, the window 212 will be displayed and within the video display windows 244 the video segments stored under the selected video content category and video content group, downloaded from the server device 20 to the sending device 10 will be played. The functionality of windows 244 is to display video segments Thus, in the drawing under discussion about twelve video display windows are shown. If the number of the relevant video segments is greater than the number of video display windows displayed then two or more pages containing about twelve video segments will be generated and user will be able to scan the pages by utilizing the “Previous page” 220, “Next page” 222 and “Return to first page” 240 buttons. Next, the user could affect the moving of the displayed content of one of the video windows 224 to the working area display 230, by dragging the video content from the video display pages 224 to the working area display 230 or alternatively by pointing and clicking on the selected video content. Control buttons “Sound” 238, “Text” 236 and “Video” 234 allow for the separate display of the diverse media-type contents already assembled into the multimedia message at each stage of the manipulation. When the user wishes to inspect the entire multimedia message that is assembled at a specific point in time then the “Play” button 244 is activated and in the preview display window 232 the created multimedia message including all the media-types assembled at that specific point in time will be played. The preview could be paused by the “Stop” button 246. When subsequent to the preview of the assembled multimedia message the user determines that the creation of the greeting message is completed then the “Send” button 242 is activated and one or more specific windows will be displayed a) for the submission of the transmission parameters, b) for receiver device's address, and c) for confirmation of the storing of the multimedia control file either on the sending device or the server device, and d) for the confirmation of the transmission of the completed multimedia greeting. In order to record a private video content segment the user activates the “Record” button 226 that will activate a video input device, such as a camcorder. The video input device will capture a video clip of a pre-determined length and will display it in the working area display 230 for suitable manipulation. The recorded video clip could be captured, recorded, stored and transmitted to the server device 20 by the interaction with a different window (not shown). In order to manipulate the video content segment in depth the “Zoom” button 228 is activated in order to zoom into a specific detail of the video frame.

Still referring to FIG. 5 the message type window 216, includes an additional menu item indicated as “Gallery” The “Gallery” menu item will generate a window (not shown) that will display either the shared video files or the private video files. Note should be taken that the above-described interactive display window is exemplary only. In other preferred embodiments of the present invention, the visual structure of the window, the constituent graphical elements, the functionalities of the graphical elements and the pre-defined interactions among the graphical elements could be entirely different as long as the proposed functionality of the apparatus and method is maintained. In other preferred embodiments, for example, the preview display window 232 could be merged into the working area display 230, the number of buttons and the functionality thereof could be modified, the menu items could be replaced by graphical structures, such as icons, the descriptions and the functionality of the menu items could differ, and the like.

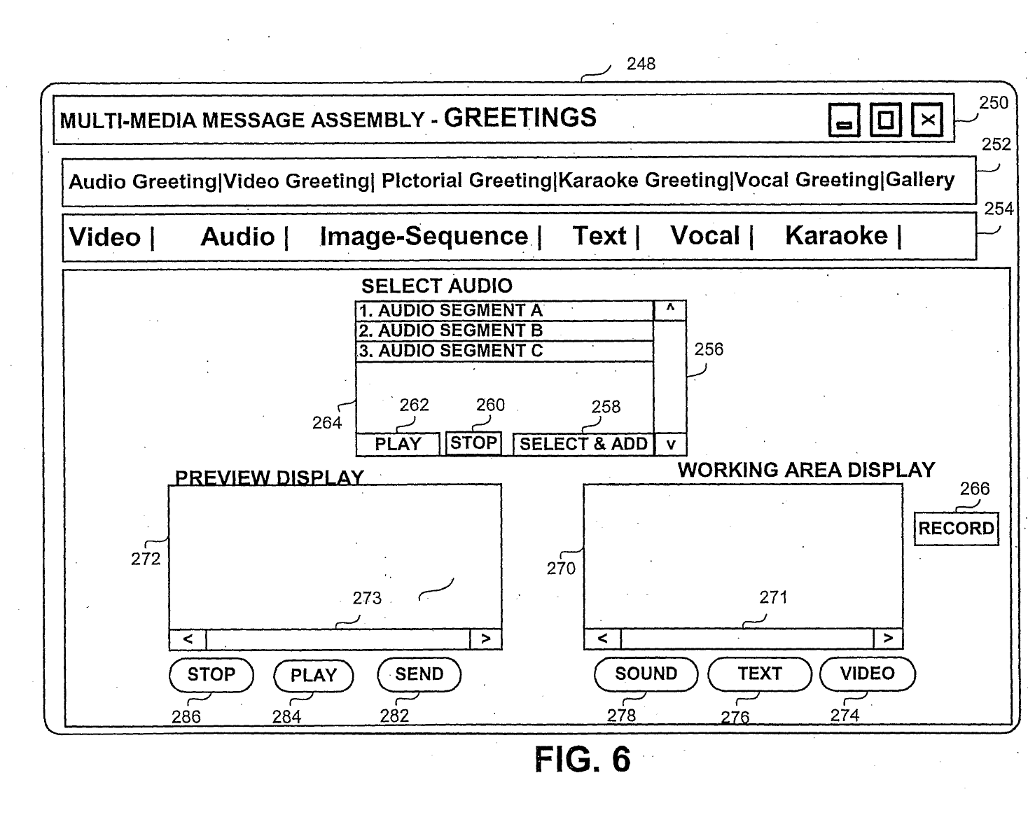

Referring to FIG. 6 window 248 is one out of a plurality of windows designed to interact with and guide a user of the sending device in the creation and transmission of a multimedia message containing a multimedia greeting. The window 248 is one of a logically interconnected set of windows that appear either by user selection or in a substantially pre-defined manner following the selection for a multimedia message type. The function of window 248 (and all the other windows participating in the creation and transmission of the multimedia message) is to interact with the user and enable the user a) to display a list of audio segments that could be part of the multimedia greeting, b) to select one or more audio segments from the list that could be part of the multimedia message, b) to manipulate the audio segments, c) to preview the multimedia message containing the multimedia greeting segments, d) to record an audio segment via a recording device, e) to create and send a composite multimedia greeting that includes either the manipulated audio segments only or includes previously created multimedia greeting that were manipulated in other windows. Window 248 includes a window header 250, a greeting message type window 252, a audio list text box 264 a preview display 272 a working area display 270, a set of audio list manipulator buttons 262, 260, 258, a set of preview manipulation buttons 286, 284 and 282, a set of working area manipulation buttons 278, 276 and 274, and a “Record” button 266. Window header 248 includes the description of the program name, and various window-manipulation buttons, such as the hide, maximize, and minimize buttons. Greeting message type window 252 includes several menu items associated with greeting message types, such as audio greeting, video greeting, pictorial greeting, text greeting, vocal greeting, and karaoke greeting. Pointing at one of the menu items and clicking the pointing device will affect the selection of a greeting message type. According to the selected greeting message type in window 248 one or more menu items are displayed in window 254 corresponding to specific media-types potentially assembled into the multimedia message containing the multimedia greeting are enabled or disabled for selection. Thus, for example when the menu item “Audio Greeting” corresponding to the creation of an audio greeting message type is selected then in window 248 the menu items “Audio Media”, and “Text Media” are enabled. The selection of one of the menu items “Audio Media”, and “Text Media” will display windows designed for the manipulation of the corresponding audio or text media-types that could be assembled into the multimedia message. Window 248 is designed for the manipulation of audio media-type. Thus, when greeting type “Audio Greeting” and the media-type “Audio Media” is selected then a window (not shown) for the selection of audio content categories and optionally of audio content groups stored in the shared creative content database on the server device will be displayed to allow the user to select the suitable audio category and audio content group. Consequent to the selection, window 248 will be displayed and within the audio list box 264 the identification of the audio segments (such as a title of a song) and stored under the selected audio category and audio group, download from the server device to the sending device will be displayed. The audio list box 264 is scrollable via the scroll bar and scroll buttons 256. Next, the user could affect the moving of the video segment the description of which is displayed in the audio list text box 264 to the working area display 270, by pointing and clicking on the description of the selected audio content. Control buttons “Sound” 278, “Text” 276 and “Video” 274 allow for the separate display of the diverse media-type contents already assembled into the multimedia message at each stage of the manipulation. When the user wishes to inspect the entire multimedia message assembled until a specific point in time then the “Play” button 284 is activated and in the preview display window 272 the created multimedia message including all the media-types assembled until a specific point in time. The preview could be paused by the “Stop” button 286 When subsequent to the preview of the assembled multimedia message the user determines that the creation of the greeting message is completed then the “Send” button 282 is activated and one or more specific windows will be displayed a) for the submission of the transmission parameters, b) for receiver device's address, and c) for confirmation of the storing of the multimedia control file either on the sending device or the server device, and d) for the confirmation of the transmission of the completed multimedia greeting. In order to record a private video content segment the user activates the “Record” button 266 that will activate an audio input device, such as a microphone. The audio input device will capture an audio clip of a pre-determined length and will display it in the working area display 270 for suitable manipulation. The recorded audio clip could be captured, recorded, stored and transmitted to the server device 20 by the interaction with a different window (not shown). Note should be taken that the above-described interactive display window is exemplary only. In other preferred embodiments of the present invention, the visual structure of the window, the constituent graphical elements, the functionalities of the graphical elements and the pre-defined interactions among the graphical elements could be entirely different as long as the proposed functionality of the apparatus and method is maintained. In other preferred embodiments, for example, the preview display window 272 could be merged into the working area display 270, the number of buttons and the functionality thereof could be modified, the descriptions and the functionality of the menu items could differ, and the like.

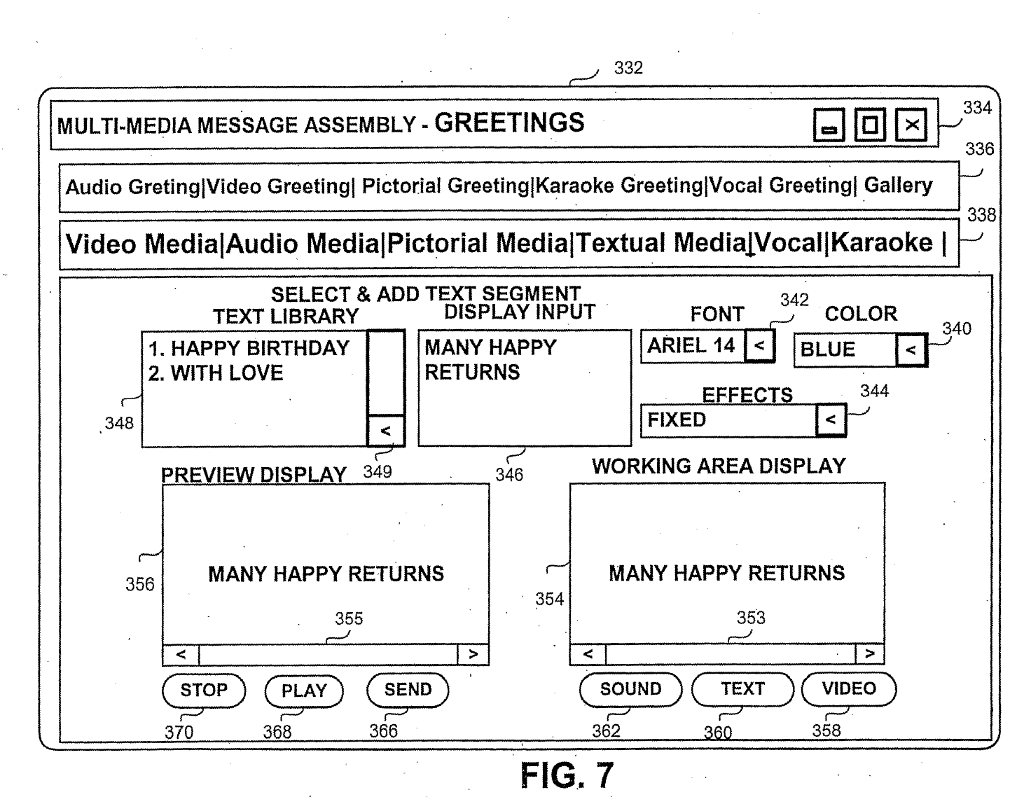

Referring to FIG. 7 window 332 is one out of a plurality of windows designed to interact with and guide a user of the sending device in the creation and transmission of a multimedia message containing a multimedia greeting. The window 332 is one of a logically interconnected set of windows that appear either by user selection or in a substantially pre-defined manner following the selection for a multimedia message type. The function of window 332 (and all the other windows participating in the creation and transmission of the multimedia message) is to interact with the user and enable the user a) to display a list of text segments that could be part of the multimedia greeting, b) to select one or more text segments from the list that could be part of the multimedia message, c) to receive customized text segments introduced by the user via a text input device, d) to manipulate the text segments, e) to preview the multimedia message containing the multimedia greeting segments, f) to create and send a composite multimedia greeting that includes either the manipulated texts segments only or includes previously created multimedia greeting that were manipulated in other windows. Window 332 includes a window header 334, a greeting message type window 336, a text segment list box 348, a text input box 346, a text library display box 348, a preview display 356, a working area display 354, a set of preview manipulation buttons 366, 368 and 370, a set of working area manipulation buttons 358, 360 and 362, a set of text format controls 342, 340 and 344, and a set of text format selection boxes 340, 342 and 344. Window header 334 includes the description of the program name, and various window-manipulation buttons, such as the hide, maximize, and minimize buttons. Greeting message type window 336 includes several menu items associated with greeting message types, such as audio greeting, video greeting, pictorial greeting, text greeting, vocal greeting, and karaoke greeting. Pointing at one of the menu items and clicking the pointing device will affect the selection of a greeting message type. According to the selected greeting message type in window 336 one or more menu items are displayed in window 338 corresponding to specific media-types potentially assembled into the multimedia message containing the multimedia greeting are enabled or disabled for selection. Thus, for example when the menu item “Text Greeting” corresponding to the creation of a text greeting message type is selected then in window 336 the menu item “Text Media” is enabled. The selection of one of the menu items “Text Greeting” and Text Media” will display windows designed for the manipulation of the corresponding text media-types that could be assembled into the multimedia message. Window 332 is designed for the manipulation of text media-type. Thus, when greeting type “Text Greeting” and the media-type “Text Media” is selected then a window (not shown) for the selection of text content categories and optionally of text content groups stored in the shared creative content database on the server device will be displayed in the text segments list box 348 to allow the user to select the suitable text category and text content group. Consequent to the selection, window 332 will be displayed and within the text segment list box 348 a list of text segments display box 348 segments stored under the selected text category and text group, download from the server device to the sending device will be displayed. The text segment list box 348 is scrollable via the scroll bar and scroll buttons 349. Next, the user could affect the moving of the text segment the description of which is displayed in the text segment list box 348 to the working area display 354, by pointing and clicking on the selected text segment. Control buttons “Sound” 362, “Text” 360 and “Video” 358 allow for the separate display of the diverse media-type contents already assembled into the multimedia message at each stage of the manipulation. The user could introduce manually a text segment into the display input box 346 by typing the text using a keyboard or other text input devices. When the user wishes to inspect the entire multimedia message assembled until a specific point in time then the “Play” button 368 is activated and in the preview display window 358 the created multimedia message including all the media-types assembled until a specific point in time. The preview could be paused by the “Stop” button 370 When subsequent to the preview of the assembled multimedia message the user determines that the creation of the greeting message is completed then the “Send” button 366 is activated and one or more specific windows will be displayed a) for the submission of the transmission parameters, b) for receiver device's address, and c) for confirmation of the storing of the multimedia control file either on the sending device or the server device, and d) for the confirmation of the transmission of the completed multimedia greeting. Text format selection boxes 342, 340 and 344 provide for the formatting of the displayed text, such as font 342, color 340, and effects 344.

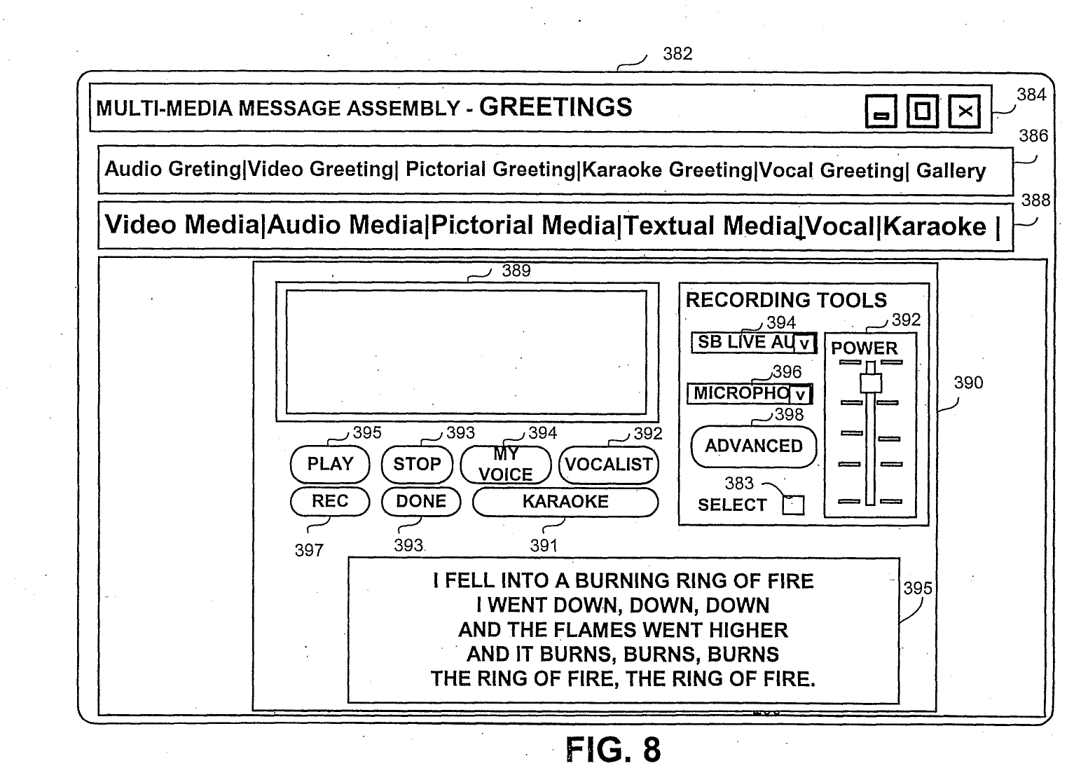

Referring to FIG. 8 window 382 is one out of a plurality of windows designed to interact with and guide a user of the sending device in the creation and transmission of a multimedia message containing a multimedia greeting. The window 382 is one of a logically interconnected set of windows that appear either by user selection or substantially sequentially following the selection for a multimedia message format. The function of window 382 (and all the other windows participating in the creation and transmission of the multimedia message) is to interact with the user and enable the user to perform and execute a karaoke sub-system. Karaoke is a form of entertainment where recorded music accompanies an amateur singer who sings along with the accompaniment on microphone. The music is typically a well-known song in which the voice of the original singer is absent or reduced in volume. Lyrics are usually also displayed as text, sometimes including color changes synchronized with the music, on music video to help with the sing-along. The manipulation of a karaoke segment involves a) to play a karaoke segment, that could be part of the multimedia greeting, b) to select a karaoke segment from the list that could be part of the multimedia message, c) to play karaoke vocals by an original vocalist synchronized with the karaoke video d) to record the karaoke lyrics performed by a user via an audio input device in order to create a karaoke segment with the original video, and the original music but with the recorded voice of the user, e) preview the multimedia message containing all the multimedia greeting segments, f) to create and send a composite multimedia greeting that includes either the manipulated karaoke segments only or includes previously created multimedia greeting that were manipulated in other windows.

Still referring to FIG. 8 window 382 includes a window header 384, a greeting message type window 386, and a karaoke panel 390. Panel 390 includes a karaoke display window 389, a lyrics display window 395 a set of karaoke control buttons 395, 393, 394, 392, 397, 393, and 391, recording tools list boxes 394, 396, a check box 383, a volume control box 392, and a control button 398. Window header 382 includes the description of the program name, and various window-manipulation buttons, such as the hide, maximize, and minimize buttons. Greeting message type window 386 includes several menu items associated with greeting message types, such as audio greeting, video greeting, pictorial greeting, text greeting, vocal greeting, and karaoke greeting. Pointing at one of the menu items and clicking the pointing device will affect the selection of a greeting message type. According to the selected greeting message type in window 386 one or more menu items are displayed in window 388 corresponding to specific media-types potentially assembled into the multimedia message containing the multimedia greeting are enabled or disabled for selection. Thus, for example when the menu item “Karaoke Greeting” corresponding to the creation of a karaoke greeting message type is selected then in window 388 the menu items “Video Media”, “Pictorial Media”, “Karaoke” and “Text Media” are enabled. The selection of one of the menu items “Karaoke Greeting” and “Karaoke” will display windows designed for the manipulation of the corresponding karaoke files that could be assembled into the multimedia message. Window 382 is designed for the manipulation of karaoke media-type. Thus, when greeting type “Karaoke Greeting” and the media-type “Karaoke” is selected then a window (not shown) for the selection of karaoke content categories and optionally of karaoke content groups stored in the shared creative content database on the server device will be displayed to allow the user to select the suitable karaoke category and karaoke content group. Consequent to the selection, window 382 will be displayed and within the karaoke play window 346 the selected karaoke segment downloaded from the server device to the sending device will be played. When the user wishes to inspect the karaoke file at any point in time the “Play” button 395 is activated and in the karaoke play window 389 the Karaoke file will be previewed. “Vocalist” button 392 will affect the playing of the karaoke segment with the lyrics sung by the original vocalist. “My Voice” button 394 will affect the playing of the karaoke segment with the lyrics sung by the user. The preview could be paused by the “Stop” button 393. When subsequent to the preview of the assembled multimedia message the user determines that the creation of the greeting message is completed then the “Done” button 393 is activated and the various pre-transmission interactive windows described herein above are activated. For the recording parameters of the recording of the lyrics during the playing of the karaoke segment recording tools panel 390 is utilized. For example, power 385 controls the volume of the recording, and list box 396 enables the selection of the audio input device.

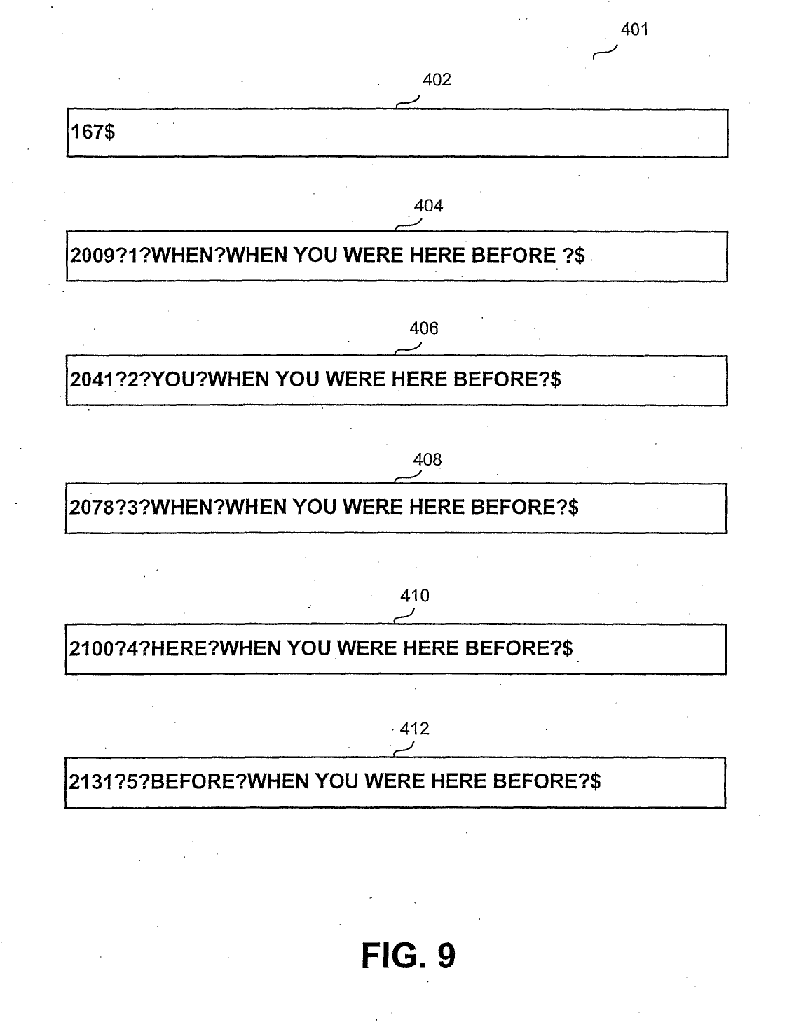

Referring now to FIG. 9 the proposed apparatus and method utilizes a novel unique karaoke text and control file synchronized with the karaoke main files. During the manipulation of the karaoke text and control file 401 the file is suitably encoded and encrypted. File 401 includes a plurality of records of specific functionality where each record is digitally encoded and encrypted. The drawing under discussion shows a header record 402 and a set of work records 404, 406, 408, 410, 412. Every record is terminated by a specific terminator character. In the preferred embodiment of the invention the terminator character is “$”. In other preferred embodiments other characters could be used as record terminators. The header record 402 holds the number of words of the lyrics appearing in a karaoke segment, such as a song. Each word record 404, 406, 408, 410 and 412 stores several fields that characterize a single word of the lyrics associated with the record 404, 406, 408, 410 and 412. The fields are separated by a specific separator character. In the preferred embodiment of the invention the separator character is “?”. In other preferred embodiments other characters could be used as field separators. The first field signifies the point in time in 1/100^{th} of a second where a word sounds audibly. The second field signifies the sequential location of the word in a sentence. The third field holds the word itself. The fourth field holds the entire sentence in which the specific word appears. Thus, for example, record 404 stores “2009” as the point in time in which the word sounds audibly, “1” signifies the sequential location of the word, “when” is the word itself, and “when you where here before, couldn't you look in the eye” is the entire sequence in which the word “when” appears. Note should be taken that in other preferred embodiments of the invention, the structure of the karaoke text and control file could be different.

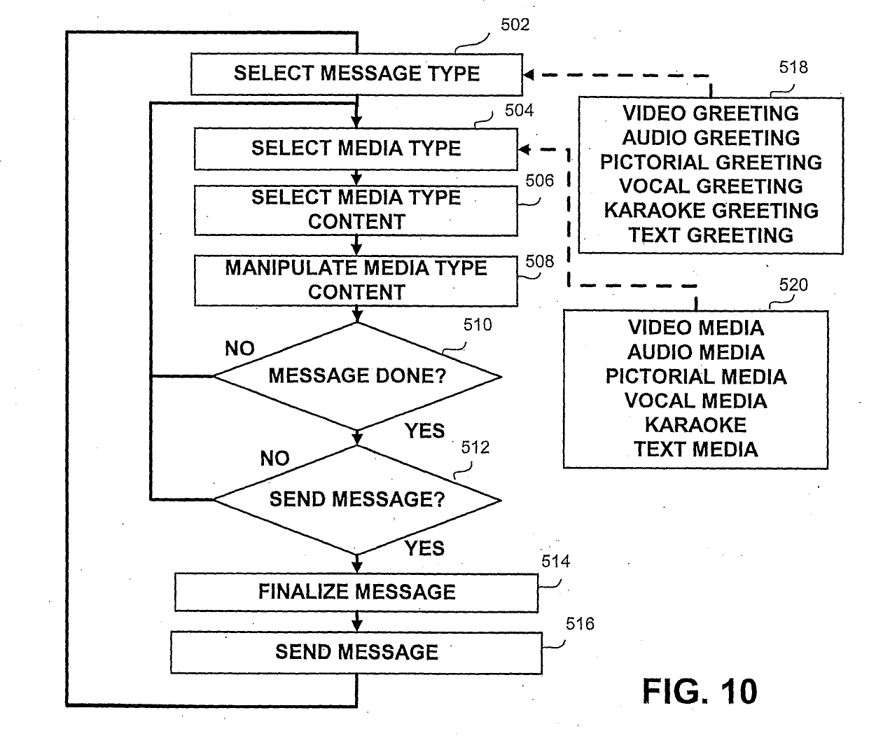

Referring now to FIG. 10 the execution of the multimedia message assembler begins at block 502 where the user is given the option of selecting a message type. In the preferred embodiment of the present invention, the multimedia message is a multimedia format greeting. The message types 518 include a) video greeting, b) audio greeting, c) pictorial greeting, d) vocal greeting, e) text greeting and f) karaoke greeting. It would be easily perceived that in other preferred embodiments additional message types could be provided for selection, such as animated greeting, graphics greeting and the like. At block 502 the message types are displayed on an interactive window as menu items, icons or the like. Consequent to the selection of the message type 518 at block 504 the user is given a message type-specific option to select a media type. In the preferred embodiment of the invention the media types 520 include a) video media, audio media, pictorial media, vocal media, text media and karaoke. The selectable media types displayed to the user are in accordance with the previous selection of the message type. Thus, for example, the selection of “Audio Greeting” as message type will enable the selection of “Audio Media”, “Vocal Media” and “Text Media”. During the creation of the “Audio Greeting” type multimedia message the specific media types, such as audio, vocal, and text, could be selected and manipulated one after the other where the completion of each manipulation affects the addition of the completed media type to the multimedia message. At block 506 the media type content is selected by the user. The media type content is typically organized by media type categories and media type groups. The media type selection involves the user choosing the desired category, the desired group, the downloading of the relevant media type content segments, and the display of the media type content segments or the descriptions of the media type content segments for the user and accepting the selection of the user. At block 508 the selected media type content segment is manipulated by the user in order to characterize the appearance of the segment and subsequently to allow for the addition of the media type content to the multimedia message. At block 510 it is determined whether the multimedia message is completed. If the result of block 510 is negative then logic control proceeds to block 504 and performs a loop across blocks 504 through 510 where the loop is traversed for each media type selected and for each media type content segment selected and manipulated. Where the result of block 510 is positive logic control exits the loop and at block 512 it is determined whether the user wishes to transmit the multimedia message to a receiver device. If the result of block 512 is negative then logic control proceeds to block 504 to perform a loop across blocks 504 through 512. If the result of block 512 is positive then at block 514 a multimedia greeting message is finalized and at block 516 the completed multimedia greeting message is sent to the receiver device. Consequently, logic control returns to block 502 for the preparation of another multimedia message.

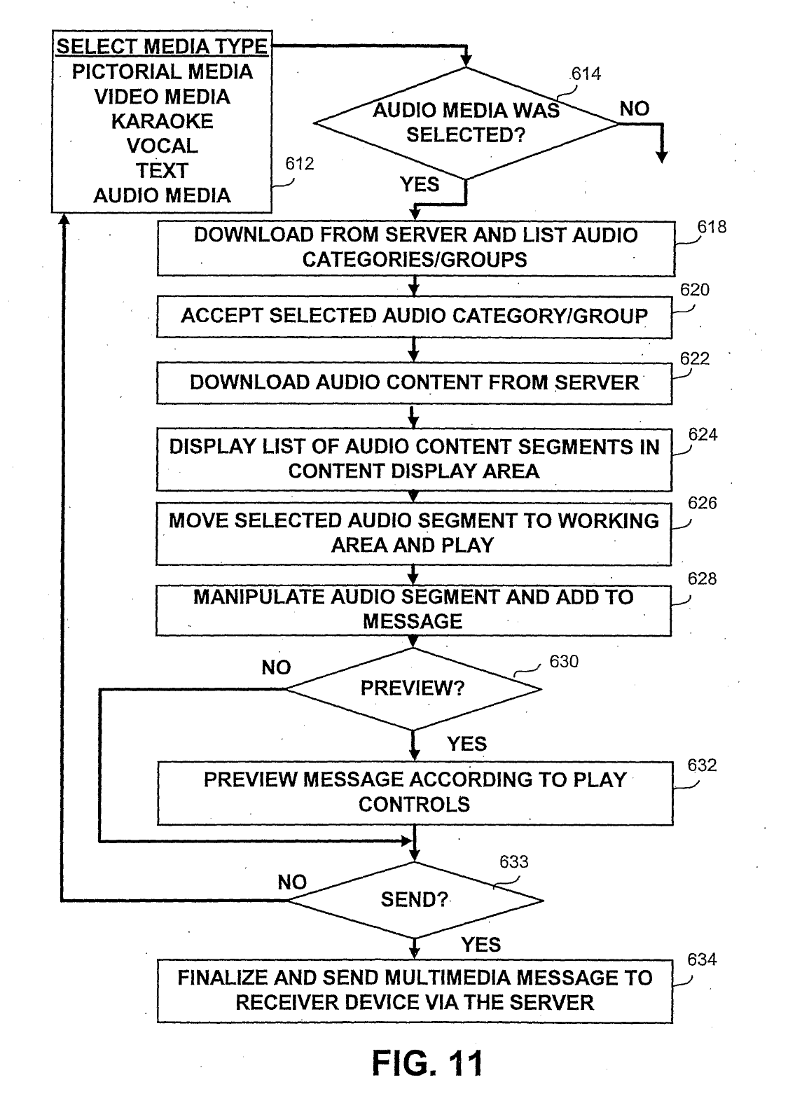

Referring now to FIG. 11 the audio media manipulation is a module of the multimedia message assembler 62 running on the sending device 10. When the module is entered at block 612 the media type is selected by the user. At block 614 it is determined whether the selected media type is audio media. If the result is positive then at 618 a list of audio media categories and audio media groups is downloaded from the server device. Next, at block 620 the selected audio media category and audio media group is accepted, at, block 622 the relevant audio media content segments are downloaded from the server device and, at block 624 the list of descriptions of the audio media segments is displayed to the user. Next, at block 626 the selected audio media segment is moved into a working area display and played in accordance with working area display controls. At block 628 the selected audio media segment and the characteristics thereof are manipulated add assembled into the multimedia message. At block 630 it is determined whether the user desires to preview the multimedia message. If the result of block 630 is positive then at block 632 the multimedia message is previewed according to the preview area display controls. Next, at block 633 it is determined whether the user wishes to send the multimedia message to a receiver device. If the result of block 633 is positive then at block 634 the multimedia message is finalized and sent to the receiver device. If the result of block 630 is negative then logic control proceeds directly to block 633. If the result of block 633 is negative then logic control returns to block 612 to enable the user to select a media type for further manipulation of a selected media type and for the assembling the manipulated media type into the multimedia message. If the result of block 614 is negative then logic control proceeds to determine if any other media types were selected (not shown).

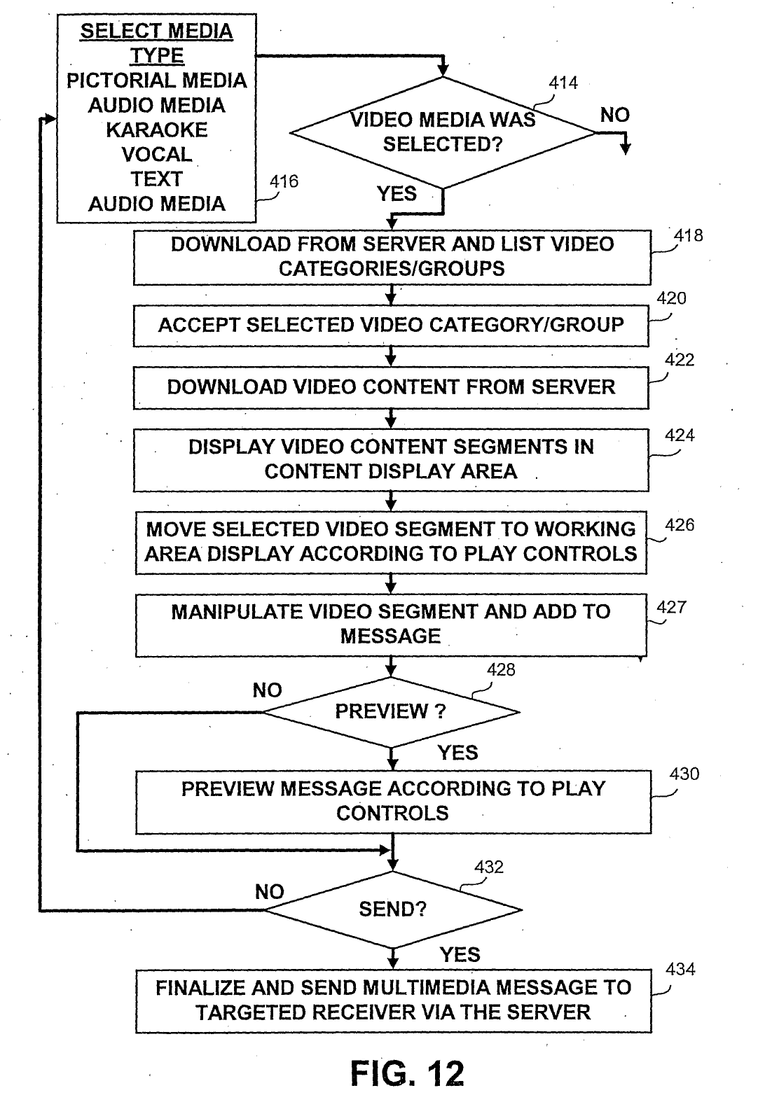

Referring now to FIG. 12 the video media manipulation module is a module of the multimedia message assembler running on the sending device. When the module is entered at block 416 the media type is selected by the user. At block 414 it is determined whether the selected media type is video media. If the result is positive then at 418 a list of video media categories and video media groups is downloaded from the server device. Next, at block 420 the selected video media category and audio media group is accepted, at block 422 the relevant video media content segments are downloaded from the server device and at block 424 the video media content segments is displayed to the user in the video content display area. Next, at block 426 the selected video media content segment is moved into a working area display and played in accordance with working area display controls. At block 427 the selected video media segment and the characteristics thereof are manipulated add assembled into the multimedia message. At block 428 it is determined whether the user desires to preview the multimedia message. If the result of block 428 is positive then at block 430 the multimedia message is previewed according to the preview area display controls. Next, at block 432 it is determined whether the user wishes to send the multimedia message to a receiver device. If the result of block 432 is positive then at block 434 the multimedia message is finalized and sent to the receiver device. If the result of block 428 is negative then logic control proceeds directly to block 432. If the result of block 432 is negative then logic control returns to block 416 to enable the user to select another media type for further manipulation of the selected media type and for the assembling the manipulated media type into the multimedia message. If the result of block 414 is negative then logic control proceeds to determine whether any other media types were selected (not shown).

Next a description of the options for the manipulation of the various media types that are supported by the proposed apparatus and method will be provided, in accordance with the first preferred embodiment of the present invention. The media types supported are a) audio, b) video, c) text, d) still images, and e) karaoke. In other preferred embodiments of the invention additional media types could be supported, such as animation, graphics, icons, and the like.

Audio media content segments could be added to any selected video media content segment, such as video clip, still image or still image sequences, and visually displayed text. The audio media content segments supported by the proposed apparatus and method could be divided into four categories: a) songs (instrumental music and vocals performed by a singer, b) music without vocals (instrumental music), c) greeting songs (a musical segment with vocals at the start of the segment and at the end of segment where between the vocal parts a space exists to allow for the insertion of a congratulatory message, and d) audio media content segments containing special effects. Audio media content segments could be obtained from a shared creative content database installed on the server machine or from a private content library installed on the sending machine or from direct recording via audio capturing devices. The proposed apparatus and method provides the options of: a) modifying the soundtrack accompanying a video media content segment by the user by selecting a different audio media content segment, b) recording the voice of a user, c) replacing the original sound with a vocal recording, d) combining the original recording with the vocal recording by mixing the audio media content segments dynamically and with synchronized timing to the vocals or the instrumental music of the original segment, and e) mixing by overlaying the recorded voice of the user on a segment selected by the user. The method is capable to lower the sound volume of the original segment during the mixing of the user's voice into the original segment.

The video media content segments and still image content segments supported by the proposed apparatus and method could be obtained from the shared creative content database installed on the server machine or from a private content library installed on the sending machine or from direct recording via video/image capturing devices connected to the sending device. Several still images could be selected to generate a still image sequence, such as in image set-based presentations where the display of the image sequence could be enhanced by special effects, such as dissolve type, and the like.

Text content segments could be added to any selected video media content segment, still image, and still image sequences. Text segments could be selected from the shared creative content database on the server device from a private library on the sending device or could be introduced into the apparatus via text input devices connected to the sending device. The text segment visual characteristics, such as font, color, letter size, and the like could be manipulated. The location of the text segment on the visual background and the direction and type of movements of the letters/words/sentences of the text segment on the visual background could be controlled. The entry point in time and the exit point in time of the text could be manipulated by the user.

The on-line karaoke sub-system provides the option to the user to record his voice on a selected audio segment. The resulting playback will be received as a song performed by the user. The song could be used as a selected audio content segment and could be overlaid on any selected video media content segment, still image sequence, and visually displayed text. Operation of the karaoke sub-system includes the following steps: a) selecting a audio media content segment containing a song the user desires to perform, b) full playback of the selected song (vocal and instrumental) where the text of the lyrics of the song are displayed in full synchronization with the rhythm and the timing of the music in order to provide for guided “rehearsals” by the user, c) recording the voice of the user during the playback of the instrumental part of the song while being assisted by the displayed text of the lyrics, d) replaying the video media segment including the song recorded by the user and the original instrumental part, and 5) optionally assembling the recorded song (user's voice, instrumentals, text of lyrics) into a multimedia message, such as a video media content or a still image sequence.

The multimedia message is typically modified during the manipulation of the different media types by the assembling of the media types into the message. The user is given the option of previewing the multimedia message at any point in time during the multimedia message assembly process. Transmission parameters, such as target address and transmission scheduling (day and time of the desired transmission) are inserted into the completed multimedia message. The message could be sent in different formats to different types of receiver devices, such as to computing device via e-mail or to a cellular telephone by using Multi Media Messaging (MMM). The completed multimedia message is transmitted from the sending device to the server device. The server software determines the type of the device associated with the receiver address and checks the multimedia capabilities of the device. In accordance with the obtained multimedia characteristics the server software a) forwards the original multimedia message, or b) reformats and forwards the multimedia message or c) saves the message and generates an SMS message to notify the receiver device concerning the manner in which the multimedia message can be viewed.

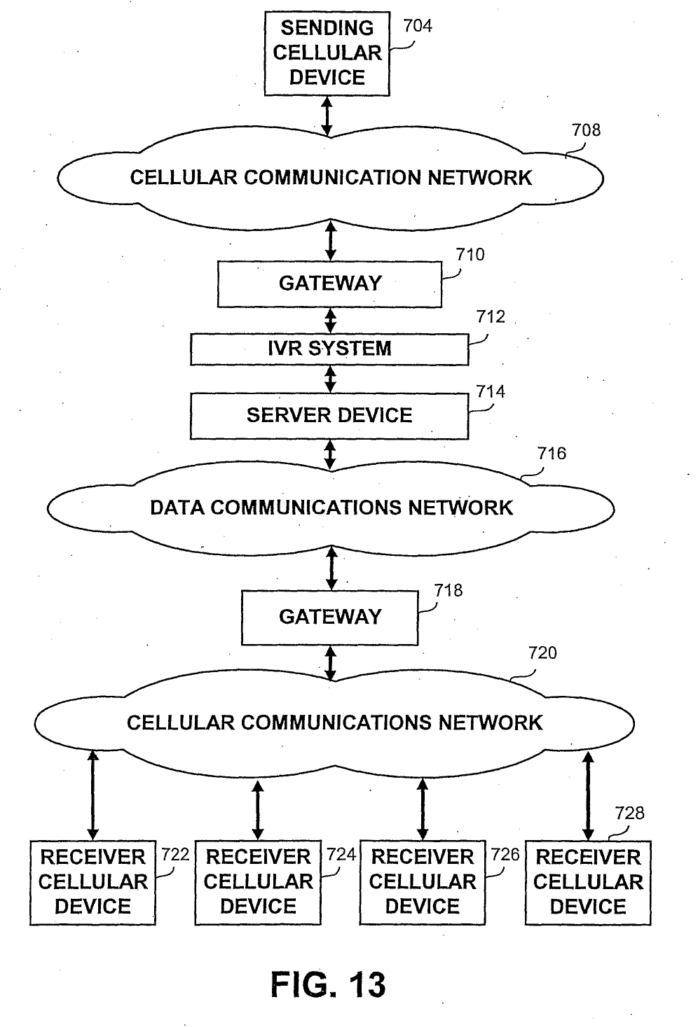

Referring now to FIG. 13 which is a schematic illustration of a computing and communication environment in which the proposed apparatus could operate, in accordance with a second preferred embodiment of the present so invention. Sending cellular device 704 is a wireless cellular communication device with enhanced computing and multimedia play capabilities, such as an advanced type of smart-phone. The term smart-phone is typically used to characterize a wireless telephone set with special computer-enabled features not previously associated with telephones. Sending cellular device 704 is linked to a cellular communication network 708 via an air interface. In the second preferred embodiment of the invention a user of the sending cellular device 704 dials a specific (typically shortened) phone number through which the wireless linking of the device 704 via the cellular communications network and a gateway device 710 to an Interactive Voice Response (IVR) system 712 is accomplished. An Interactive Voice Response (IVR) system is a software application that accepts a combination of voice telephone input and touch-tone keypad selection and provides appropriate responses in the form of voice, fax, callback, e-mail and other media. IVR is usually part of a larger application that includes database access. IVR system 712 operates on-line and works in synchronization with the server device 714. The user of sending cellular device 704 controls the operation of the server device 714 via an IVR interface associated with the IRV system 712 by suitably responding to a dynamic voice menu provided the IRV system 712. The suitable responses include the pressing of the appropriate keys installed on the faceplate of the sending cellular device 704 for the selection of multimedia generation options and the recording of vocal messages, such as short lyrics, personal identification, or spoken word sequences for the enhancement of the multimedia message. In the second preferred embodiment of the invention, the server device 714 includes a user request handler to respond to the requests of a user of the sending cellular device 704, a multimedia message assembler to create a unique dynamically personalized multimedia message in accordance with the requests of the user, and a shared creative content database to store media-type content segments and to hold multimedia message output and control files. As in the first preferred embodiment of the invention, the multimedia message assembler is a set of inter-related software programs the functionality of which is to manipulate the media-type content segments in order create, to compose, to assemble, to produce and to transmit the unique dynamically personalized multimedia output message. The multimedia message is provided by the user of the sending cellular device 704 with a suitable receiver cellular device dialing number. Consequently, the multimedia message is transmitted from server device 714 via a data communications network 716, a gateway device 718 and a cellular communications network 720 to the receiver cellular devices 722, 724, 726 and 728. Server device 714 is a computing device the functionality of which is: a) interactive manner via the IVR interface requests from the sending receiving in an cellular device 704 regarding the assembly of a multimedia message on the server device 714 b) assembling the multimedia messages for the sending cellular device 704, c) providing the multimedia message for the sending cellular device 704 for playback and review, and d) transmitting the multimedia message to one or more receiver cellular devices 722, 724, 726 and 728 via gateway 718 and cellular communications network 720. The receiver cellular devices 722, 724, 726 and 728 are cellular telephone devices with multimedia content playing capabilities. The multimedia message is received by the receiver cellular devices 722, 724, 726 and 728 and is replayed by the users of devices 722, 724, 726 and 728 in order to perceive the content of the message. As in the first preferred embodiment of the invention, server device 714 includes a multimedia message forwarding mediator. In response to requests of the user of the sending cellular device 704 via the IVR system 712 specific media-type content segments are fetched from the shared creative content database in order to supply the multimedia message assembler with the media elements for the creation of the multimedia message. Multimedia message forwarding mediator is a software program for the handling of the received multimedia messages, such as receiving the messages from the assembler, communicating with the receiver cellular devices, responding to the capabilities of the receiver cellular devices, optionally re-formatting the messages in accordance with the characteristics of the receiver cellular devices and forwarding the messages to the receiver cellular devices. Note should be taken that although on the drawing under discussion only a single sending cellular device, a single server device and several receiver cellular devices are shown, in a realistic environment a plurality of sending cellular devices could request the assembly of a plurality of multimedia output messages from a plurality of server devices and could request the transmission of the messages to a plurality of receiver cellular devices via the plurality of the server devices.

The media types supported by the proposed apparatus and method, in accordance with the second preferred embodiment of the present invention is a) audio, b) video and c) text. The audio includes pre-pre-prepared and pre-stored greeting songs, instrumental music, lyrics accompanied by instrumental music, recorded vocal greetings that could be combined dynamically with the music, and the like. The addition of text is accomplished by obtaining a pre-prepared text segment from the shared creative content database based on the selection of the sending cellular device. The text could be specifically customized by the insertion of lyrics, and spoken words that are recorded on-line by the user of the sending cellular device. The addition of video is accomplished by obtaining a pre-prepared and pre-stored video segment from the shared creative content database based on the selection of video segment category and video segment group by the user of the sending cellular device.

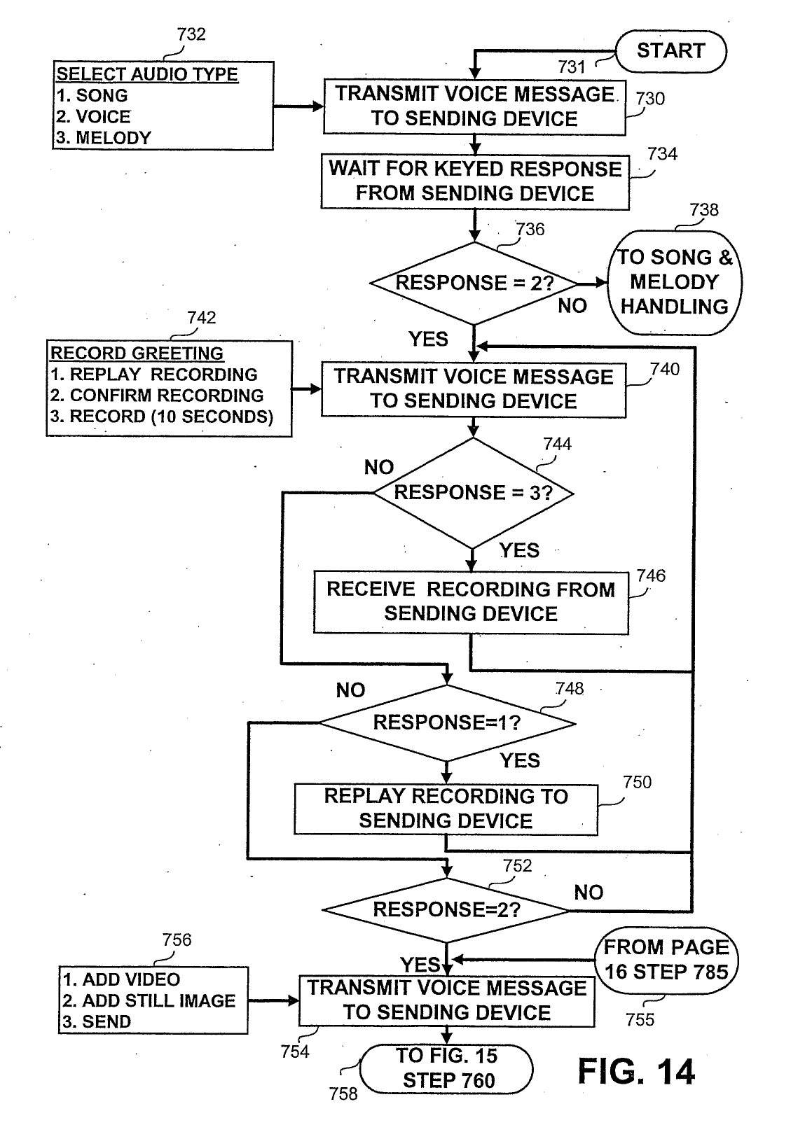

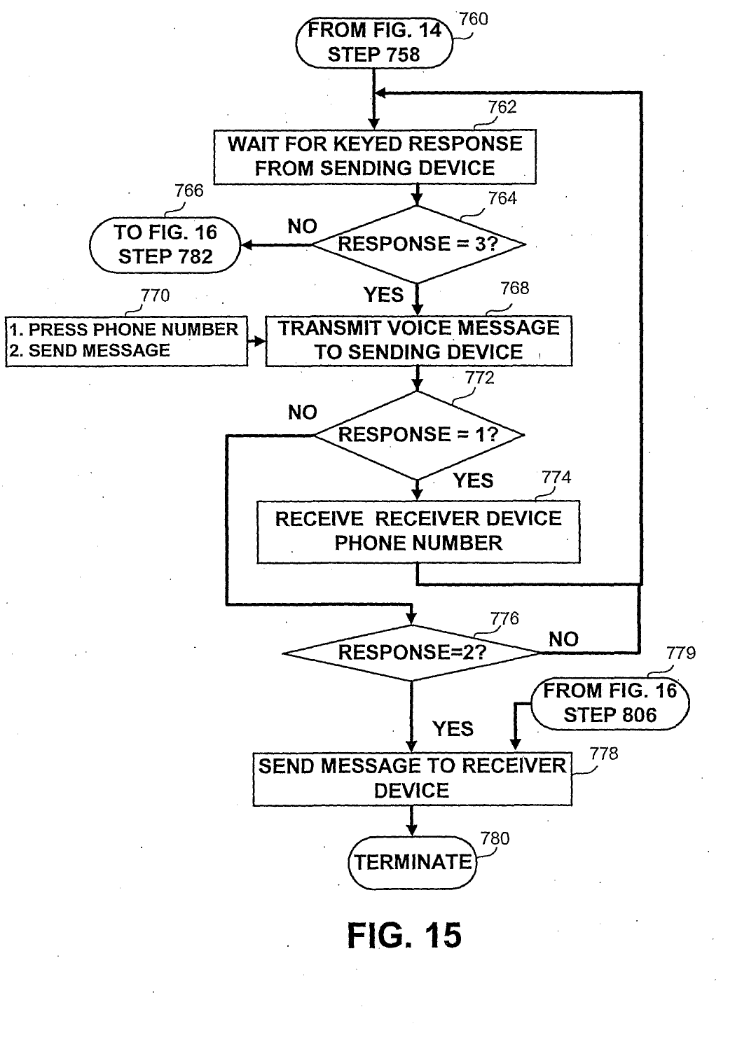

Referring to FIGS. 14, 15 and 16 in the second preferred embodiment of the present invention, the user interface designed for the apparatus and method is an Interactive Voice Response (IRV) interface. IVR is a computerized system that allows a person, typically a telephone caller, to select an option from a voice menu and otherwise interface with a computer system. Generally the system plays pre-recorded voice prompts to which the person presses a number on a telephone keypad to select the option chosen, or speaks simple answers such as “yes”, “no”, or numbers in answer to the voice prompts. Referring specifically to FIG. 14 at step 731 the method is initiated and at action step 730, in response to an identified call from a user of a sending cellular device and the subsequent identification of the service required, the server device activates the IRV system. The IRV system utilizes a pre-recorded voice menu file 732 that includes application-specific selectable options that the user of the sending cellular device could choose in order to begin the assembly of a multimedia message, such as a multimedia greeting. Further, at action step 730 the file 732 is transmitted to the sending cellular device and replayed as a vocal message for the user. At action step 734 the server device in association with the IRV system waits for a keyed response from the sending device until the response is received. At determination step 736 the keyed-in response is examined in order to determine which of the options detailed in the file 732, the user of the sending device have selected. If the result of determination step 736 is “2” then the user selected the “Voice” option from the file 732. The “Voice” option allows the user to record a personal vocal greeting message to be included in the multimedia message file. At action step 740 a recording controlling audio file 742 is obtained and transmitted to the user of the sending cellular device for replay. Audio file 742 includes a list of selectable options the selection thereof would control the performance of the recording by the user. At determination step 744 it is determined whether the user responded by pressing the “3” key that indicates that the user wishes to record a vocal message or a lyrics of a song. If the result of determination step 744 is positive then at action step 746 the server receives the recording from the sender cellular device and subsequently logic control proceeds to action step 740. If the result of determination step 744 is negative then it is determined at determination step 748 whether the user responded by pressing the “1” key that indicates that the user desires to listen to the recorded message or lyrics. If the result of step 748 is positive then at action step 750 the recording is sent to the sending cellular device in order to be replayed to the user and logic control proceeds to step 740. If the result of determination step 744 is negative that at determination step 752 it is determined whether the user pressed the “2” key indicates the request of the user to confirm the recording. If the result of step 752 is negative then logic control proceeds to step 740. If the result of step 752 is positive then at action step 754 an audio file 756 including options for the addition of visual elements to the multimedia message is obtained and transmitted to the sending cellular device in order to replay it to the user. Consequently logic control proceeds to FIG. 15 step 760 through page connector indicator 758.

Still referring to FIG. 14 if at determination step 736 is determined that the result of the step is negative then logic control proceeds via page connector selector 738 to a specific “Song and Melody handling” module. Song and Melody handling module will provide the user with the audio menus and the appropriate operations that allow for the insertion of specifically selected songs (with lyrics and instrumental music) or melodies (instrumental music). The flow charts describing the operation of the Song and Melody handling module will not be shown and detailed in the present application since the operation thereof is in principle similar to the Video and Image handling module that is going to be described hereinafter in association with the following drawings.

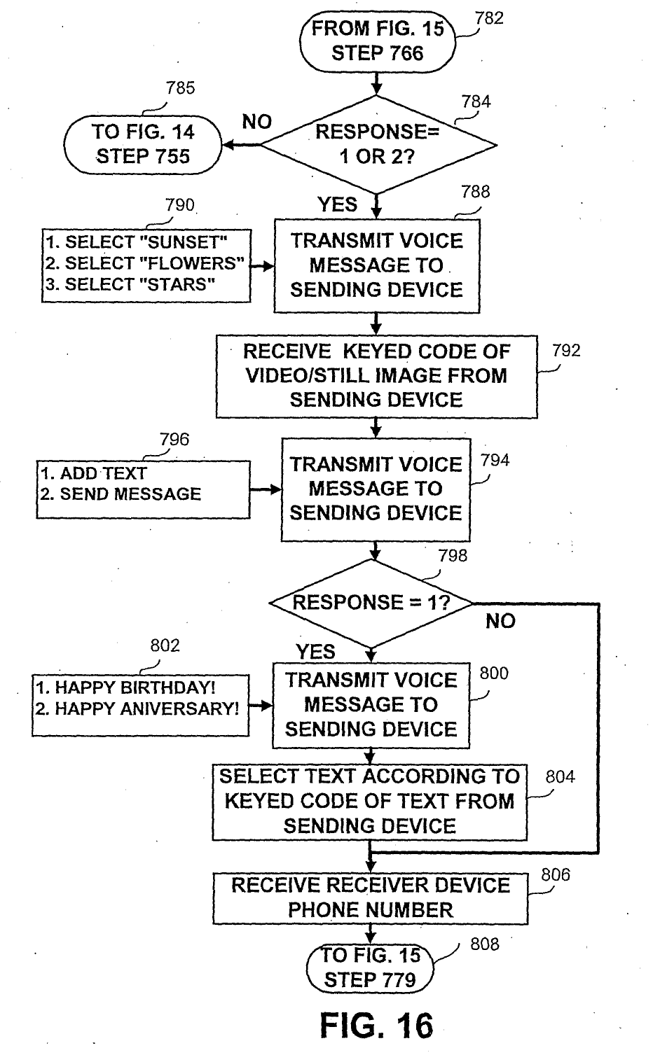

Referring specifically to FIG. 15 logic control proceeds through page connector indicator 760 to action step 762. At action step 762 the server waits for a keyed response from the sending cellular device. At determination step 764 it is determined whether the response of the user of the sending cellular device includes a pressing of the “3” key. Pressing the “3” key indicates that the user wishes to transmit the multimedia message to a receiver cellular device. If the result of step 764 is positive then at step 768 the audio file 770 used for obtaining the options associated with the control of the message transmission is obtained and sent to the user of the sending cellular device for replay. At determination step 772 it is determined whether the keyed response is “1”. By pressing the “1” key the user indicates that a cellular phone number identifying the receiver cellular device will follow. If the result of step 772 is positive then at step 774 the receiver cellular device phone number is received and logic control returns to step 762. If the result of step 772 is negative then at step 776 it is determined whether the “2” key was pressed by the user of the sending cellular device. Since the “2” key indicates a request of the user for message transmission at step 778 the multimedia message is transmitted to the receiver cellular device and at 780 the operation is terminated. If the result of step is negative then logic control proceeds to FIG. 16 step 782 via page connector indicator 766 for Video and Image handling.

Referring specifically to FIG. 16 logic control proceeds to determination step 784 through page connector indicator 782. At step 784 it is determined whether the response of the user of the sending cellular device was a) pressing of the “1” key or b) pressing of the “2” key. Pressing key 1 indicates that user desires to insert a video clip into the multimedia message for assembly. Pressing key 2 indicates that user desires to insert a still image into the multimedia message for assembly. If the result of step 784 is positive then at step 788 a video/image selection menu file 790 is obtained and sent for display to the user of the sending cellular device. Menu file 790 includes a list of selectable video clips or still images with associated codes that enable the user to select there from for assembly into the multimedia message. At action step 792 the code identifying the video clips/images is received from the user. At action step 794 a text addition control menu file 796 is obtained, transmitted to the sending device and displayed to the user of the sending device. The file 794 includes a) a text addition menu item and a b) message sending menu item. At determination step 798 it is determined whether the user selected the text addition option by pressing the “1” key. If the result of step 798 is positive then at step 800 a text segments list audio file 802 is obtained and transmitted to the sending cellular device in order to replay it to the user. At step 804 the text segment selected by the user is obtained and assembled into the multimedia message and at action step 806 the phone number identifying the receiver cellular device is received from the user. Consequently, logic control proceeds to FIG. 15 step 779 through page connector indicator 808 for the transmission of the multimedia message to the receiver device. If the result of determination step 784 is negative then logic control proceeds to FIG. 14 step 755 via page connector indicator 785 to replay audio file 756 and repeatedly perform of the handling of Video and Image selection module.

Note should be taken that the above-described logical flow is exemplary only. In other preferred embodiments of the present invention, the method of operation, the structure of the audio menu files, the menu items appearing within the audio menu files, the logical sequence of the menu replays, and the type of responses allowed for the replayed menus, the type of responses, the descriptions and the functionality of the menu items and the like, could be entirely different as long as the proposed functionality of the apparatus and method is maintained. In other preferred embodiments, for example, the a voice-to-text option could be used in lieu of pressing keys on a keypad number of buttons or other advanced features could be used. In addition, the vocally replayed menus and menu items could be replaced by the display of graphical structures, such as icons, could differ, and the like. In such a case the selection of menu items could be performed by a touch-screen device or the like.

It will be appreciated by persons skilled in the art that the present invention is not limited to what has been particularly shown and described hereinabove. Rather the scope of the present invention is defined only by the claims which follow.

1. An apparatus for the creation and transmission of personalized multimedia messages, the apparatus comprising:
a multimedia message assembler for creating a multimedia message by assembling and manipulating diverse media type content segments;
a shared creative content database to store diverse media type content segments and to provide the diverse media type content segments to the multimedia message assembler in response to a request; and
a multimedia message forwarding mediator to receive multimedia messages and receivers addresses associated therewith, to communicate with a receiver device, to reformat the multimedia message according to the multimedia capabilities of the receiver device, and to forward the multimedia message to the receiver device.

2. The apparatus of claim 1 wherein the multimedia message assembler comprises tools for selecting, recording, joining, editing and composing diverse media type content segments and a user interface for allowing a user to select one of said tools.

3. The apparatus of claim 1 wherein the diverse media type content segments include audio segments, video segments, text segments and still images.

4. The apparatus of claim 1 further comprising a multimedia message player to play a multimedia message.

5. The apparatus of claim 1 further comprising a shared creative content downloader to obtain media type content segments from a data communication network.

6. The apparatus of claim 1 further comprising media type content capture software to capture media-type content segments.

7. The apparatus of claim 1 further comprising:
a private creative content library to store private media type content files; and
a private creative content uploader to transmit private media type content segments to a data communications network for storage and subsequent utilization.

8. The apparatus of claim 1 wherein the multimedia message assembler comprises a media content synchronizer to synchronize the media type segments in the multimedia message; and
a multimedia message generator to generate an assembled multimedia message out of diverse manipulated media type content segments.

9. The apparatus of claim 1 wherein the multimedia message assembler comprises:
a video and animation editor to manipulate video media and animation media segments;
a still image and image sequence editor to manipulate still image segments;
a sound editor to manipulate audio media segments; and
a text editor to manipulate text media segments.

10. (canceled)

11. (canceled)

12. The apparatus of claim 1 wherein the shared creative content database comprises:
a shared video files for providing requested video content segments to the multimedia message assembler;
shared audio files for providing requested audio media content segments to the multimedia message assembler;
shared still image files for providing requested still image media content segments to the multimedia message assembler; and
shared karaoke files for providing requested karaoke content segments to the multimedia message assembler.

13. (canceled)

14. The apparatus of claim 1 further comprising:
a creative content request handler to respond to requests for media type content segments stored in the shared creative database by the multimedia message assembler;
a creative content extractor module to obtain requested media type content segments from the shared creative content database; and
a creative content transmitter module to send the requested and obtained media type content segments to the multimedia message assembler.

15. (canceled)

16. (canceled)

17. The apparatus of claim 1 further comprising a multimedia message control file for subsequent structural and contextual reconstruction of a multimedia message file associated with the multimedia message to be transmitted to the receiver device.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. The apparatus of claim 1 wherein the media type content segments comprise:
audio media content segments for being assembled into the multimedia message;
video media content segments for being assembled into the multimedia message;
text media content segments for being assembled into the multimedia message;
Image media content segments for being assembled into the multimedia message; and
karaoke media content segments for being assembled into the multimedia message.

31. (canceled)

32. (canceled)

33. (canceled)

34. A method for the creation and transmission of unique personalized multimedia messages from a sending device to a receiver device, the method comprising:
obtaining media type content segments from a shared creative content database;
creating a multimedia message by assembling and manipulating the diverse media type content segments; and
forwarding the multimedia message to the receiver device.

35. The method of claim 34 wherein said assembling and manipulating is performed by means of a user interface provided at the sending device.

36. (canceled)

37. The method of claim 34 wherein said assembling and manipulating include selecting, recording, editing and joining the diverse media type content segments.

38. The method of claim 34 further comprising:
selecting a message type for the creation of a multimedia message;
selecting a media type for manipulation and assembly into the multimedia message submitting requests for media type contents to a shared or private creative content database;
selecting a media type content segment from the obtained media type content segments;
manipulating the selected media type content segment and adding the manipulated media type content to the multimedia message;
finalizing the multimedia message; and
transmitting the finalized multimedia message to a multimedia message forwarding mediator.

39. The method of claim 34 further comprising:
inserting the address of the receiver device into the multimedia message;
inserting transmission scheduling parameters into the multimedia message;
transmitting the multimedia message in accordance with the transmission scheduling parameters.

40. The method of claim 34 further comprising:
communicating with the receiver device for obtaining the multimedia capabilities of the receiver device;
reformatting the multimedia message in accordance with the obtained multimedia capabilities of the receiver device.

41. The method of claim 40 further comprising the step of notifying the receiver device regarding the display options of the multimedia message.

42. The method of claim 34 further comprising:
capturing media type content segments through media capture devices; and
recording media type content segments through recording devices.

43. (canceled)

44. (canceled)

45. The method of claim 34 further comprising:
uploading media type content segments from the private creative content library to the shared creative content library; and
downloading media type content segments from the shared creative content library to the private creative content library.

46. (canceled)

47. (canceled)

48. (canceled)

49. (canceled)

50. (canceled)

51. (canceled)

52. (canceled)

53. (canceled)
